(19) United States
(12) Patent Application Publication
(10) Pub. No.: US 2026/0336545 A1
(43) Pub. Date: Oct. 29, 2026

(54) METHOD, APPARATUS AND DEVICE FOR PROCESSING VEHICLE ROAD NOISE, STORAGE MEDIUM AND PRODUCT

(71) Applicant: GOERTEK INC., Weifang (CN)

(72) Inventors: Xiangjie KONG, Weifang (CN); Jiaxin WU, Weifang (CN); Yongbao MA, Weifang (CN); Xudong GUO, Weifang (CN)

(21) Appl. No.: 19/347,976

(22) Filed: Oct. 2, 2025

Related U.S. Application Data
(63) Continuation of application No. PCT/CN2025/107032, filed on Jul. 4, 2025.

(30) Foreign Application Priority Data
Apr. 29, 2025 (CN) 202510550136.8

(51) Int. Cl. B60R 16/037; G10K 11/178

(52) U.S. Cl. CPC B60R 16/037; G10K 11/17854; G10K 2210/1282

(57) ABSTRACT

A method for processing vehicle road noise includes: performing sub-band decomposition on an input time domain reference signal and an input time domain error signal; dynamically determining a target update step size corresponding to sub-band adaptive filter coefficients based on acquired influencing factor information, where the influencing factor information includes environmental state information and/or sensor state information; updating the sub-band adaptive filter coefficients according to the target update step size based on the sub-band reference signal and the sub-band error signal; performing sub-band synthesis on the updated sub-band adaptive filter coefficients to obtain updated time domain adaptive filter coefficients; and processing a newly input time domain reference signal based on the updated time domain adaptive filter coefficients to obtain an anti-noise signal, thereby controlling road noise based on the anti-noise signal.

### CROSS-REFERENCE TO RELATED APPLICATIONS

This application is a continuation application of International Application No. PCT/CN2025/107032, filed on Jul. 4, 2025, which claims priority to Chinese Patent Application No. 202510550136.8, filed on Apr. 29, 2025. The disclosures of the above-mentioned applications are incorporated herein by reference in their entireties.

### TECHNICAL FIELD

The present application relates to the technical field of noise reduction, and in particular to a method, an apparatus and a device for processing vehicle road noise, a storage medium and a product.

### BACKGROUND

As the automotive industry develops, the comfort and quietness of vehicle cabins are gaining increasing attention from both the industry and consumers. As a key factor affecting in-cabin acoustic quietness and the overall riding experience, interior noise has gradually become a significant concern within the industry. In-cabin noise primarily originates from the vehicle's powertrain and road noise during driving. With the development of new energy vehicles, electric motors are gradually replacing internal combustion engines, significantly reducing engine noise. Therefore, road noise cancellation (RNC) technology has become an important means of improving in-cabin acoustic comfort. RNC technology combines a reference signal collected by a vibration sensor with an error signal collected by an in-vehicle microphone to generate an acoustic signal with the opposite characteristics of the noise. This signal is then played through the vehicle's speakers to offset the original noise. Although the existing RNC system has been applied to some mass-produced models, in complex actual application environments, the existing RNC system has insufficient adaptability or poor stability, which can lead to delayed response or unstable output, seriously affecting the driving experience.

The above content is only used to assist in understanding the technical solution of the present application and does not constitute an admission that the above content is prior art.

### SUMMARY

The main purpose of the present application is to provide a method, an apparatus and a device for processing vehicle road noise, a storage medium and a product, aiming to solve the problem that the existing RNC system has insufficient adaptability or poor stability, which may lead to delayed response or unstable output.

In order to achieve the above purpose, the present application provides a method for processing vehicle road noise, including:
performing sub-band decomposition on an input time domain reference signal and an input time domain error signal to obtain a sub-band reference signal and a sub-band error signal;
dynamically determining a target update step size corresponding to sub-band adaptive filter coefficients based on acquired influencing factor information, where the influencing factor information includes environmental state information and/or sensor state information, the environmental state information is information representing an environmental state inside and/or outside a vehicle, the sensor state information is information representing an operating state of a sensor, and the sensor includes the sensor for collecting the time domain reference signal and/or the sensor for collecting the time domain error signal;
updating the sub-band adaptive filter coefficients according to the target update step size based on the sub-band reference signal and the sub-band error signal;
performing sub-band synthesis on the updated sub-band adaptive filter coefficients to obtain updated time domain adaptive filter coefficients; and
processing a newly input time domain reference signal based on the updated time domain adaptive filter coefficients to obtain an anti-noise signal, thereby controlling road noise based on the anti-noise signal.

In an embodiment, when dynamically determining the target update step size based on the influencing factor information, one or more of the following rules is met:
under the environmental state represented by the environmental state information, the target update step size corresponding to a sub-band with higher road noise energy or higher stability is larger than the target update step size corresponding to a sub-band with lower road noise energy or lower stability;
for any target sub-band, the higher the energy or the higher the stability of the vehicle road noise in the target sub-band under the environmental state represented by the environmental state information, the larger the target update step size corresponding to the target sub-band; and the lower the energy or the lower the stability of the vehicle road noise in the target sub-band under the environmental state represented by the environmental state information, the smaller the target update step size corresponding to the target sub-band;
based on abnormality level of each sensor represented by the sensor state information, the target update step size corresponding to the sub-band containing the sensor with higher abnormality level is smaller than the target update step size corresponding to the sub-band containing the sensor with lower abnormality level; and
for any target sub-band, the higher the abnormality level of the sensor in the target sub-band, the smaller the target update step size corresponding to the target sub-band; and the lower the abnormality level of the sensor in the target sub-band, the larger the target update step size corresponding to the target sub-band.

In an embodiment, the dynamically determining the target update step size corresponding to the sub-band adaptive filter coefficients based on the acquired influencing factor information includes:
determining an update step length corresponding to the influencing factor information as a target update step length according to a preset mapping relationship, where the mapping relationship satisfies one or more of the above rules.

In an embodiment, the influencing factor information further includes a vehicle speed, and when dynamically determining the target update step size based on the influencing factor information, one or more of the following rules is met:
the higher the vehicle speed stability, the larger the target update step size corresponding to each sub-band; and the lower the vehicle speed stability, the smaller the target update step size corresponding to each sub-band; and
the target update step size corresponding to each sub-band when the vehicle speed is beyond a preset range is smaller than the target update step size corresponding to each sub-band when the vehicle speed is within the preset range.

In an embodiment, the method further includes:
performing prediction based on the input time domain reference signal, the input time domain error signal, the sub-band reference signal and the sub-band error signal through a preset prediction model to obtain the environmental state information and/or the sensor state information, where the prediction model is pre-trained.

In an embodiment, the prediction model includes a first feature extraction module, a second feature extraction module, a third feature extraction module, a feature fusion module and a prediction module;
the performing prediction based on the input time domain reference signal, the input time domain error signal, the sub-band reference signal and the sub-band error signal through the preset prediction model to obtain the environmental state information and/or the sensor state information includes:
inputting the sub-band reference signal and the sub-band error signal into the first feature extraction module for feature extraction to obtain a first feature representation;
inputting the input time domain reference signal into the second feature extraction module for feature extraction to obtain a second feature representation;
inputting the input time domain error signal into the third feature extraction module for feature extraction to obtain a third feature representation;
concatenating the first feature representation, the second feature representation, and the third feature representation and inputting into the feature fusion module for feature fusion to obtain a fused feature representation; and
inputting the fused feature representation into the prediction module for prediction to obtain the environmental state information and/or the sensor state information.

In an embodiment, each of the first feature extraction module, the second feature extraction module, and the third feature extraction module includes at least one convolutional layer; the feature fusion module includes a frequency-axis gated recurrent unit, a time-axis gated recurrent unit, and at least one transposed convolutional layer connected in sequence; and the prediction module includes multiple task output layers, and each task output layer is configured to output the environmental state information or the sensor state information.

In an embodiment, the prediction module further includes a shared feature extraction layer disposed before the multiple task output layers, and the shared feature extraction layer includes one or more convolutional layers.

In an embodiment, the environmental state information includes weather condition information and road condition information.

In an embodiment, a frame index of the input time domain reference signal and the input time domain error signal is 1, and the method further includes:
during N interrupts in (l+1)th frame, performing a task allocated to the N interrupts, where N represents a frame length, and interrupt refers to a period between generating an anti-noise signal based on the time domain reference signal at each sampling point and receiving the time domain reference signal at a next sampling point; and
where the task allocated to the N interrupts includes the task for calculating the updated time domain adaptive filter coefficients, and/or the task for predicting the environmental state information and/or the sensor state information through the prediction model.

In an embodiment, the task for calculating the updated time domain adaptive filter coefficients is divided into a sub-band decomposition task, a sub-band synthesis task, and a multiple sub-band update task;
each sub-band update task includes: updating at least one sub-band adaptive filter coefficient, assigning the sub-band decomposition task to a first preset number of interrupts for execution, assigning the sub-band synthesis task to a second preset number of interrupts for execution, and assigning the multiple sub-band update task to a third preset number of interrupts for execution, with one sub-band update task assigned to each interrupt; and
a sum of the first preset number, the second preset number, and the third preset number is N.

In an embodiment, the updating the sub-band adaptive filter coefficients according to the target update step size based on the sub-band reference signal and the sub-band error signal includes:
convolving the sub-band reference signal with a pre-established secondary path model; and
calculating updated sub-band adaptive filter coefficients through a complex-domain LMS algorithm based on the sub-band error signal, the sub-band reference signal after convolution with the secondary path model, and the current sub-band adaptive filter coefficients.

In an embodiment, the sensor for collecting the time domain reference signal includes at least one vibration sensor, and the sensor for collecting the time domain error signal includes at least one microphone.

In an embodiment, the influencing factor information further includes signal characteristics of the vibration sensor, and the signal characteristic includes acceleration amplitude, energy, and sound pressure signal amplitude.

In an embodiment, the performing sub-band decomposition on the input time domain reference signal and the input time domain error signal to obtain the sub-band reference signal and the sub-band error signal includes:
performing preprocessing on the input time domain reference signal and the input time domain error signal, and performing sub-band decomposition on the preprocessed time domain reference signal and the preprocessed time domain error signal respectively to obtain the sub-band reference signal and the sub-band error signal, where the preprocessing includes pre-filtering processing and/or amplitude adjustment processing.

In an embodiment, the processing the newly input time domain reference signal based on the updated time domain adaptive filter coefficients to obtain the anti-noise signal, thereby controlling road noise based on the anti-noise signal includes:
processing the newly input time domain reference signal based on the updated time domain adaptive filter coefficients to generate the anti-noise signal; and
playing the anti-noise signal through a speaker located within the vehicle, or post-processing the anti-noise signal and playing the anti-noise signal through the speaker located within the vehicle.

Besides, in order to achieve the above objective, the present application further provides an apparatus for processing vehicle road noise, including:
a sub-band decomposition module, configured for performing sub-band decomposition on an input time domain reference signal and an input time domain error signal to obtain a sub-band reference signal and a sub-band error signal;
a step size updating module, configured for dynamically determining a target update step size corresponding to sub-band adaptive filter coefficients based on acquired influencing factor information, where the influencing factor information includes environmental state information and/or sensor state information, the environmental state information is information representing an environmental state inside and/or outside a vehicle, the sensor state information is information representing an operating state of a sensor, and the sensor includes the sensor for collecting the time domain reference signal and/or the sensor for collecting the time domain error signal;
a filter updating module, configured for updating the sub-band adaptive filter coefficients according to the target update step size based on the sub-band reference signal and the sub-band error signal;
a sub-band synthesis module, configured for performing sub-band synthesis on the updated sub-band adaptive filter coefficients to obtain updated time domain adaptive filter coefficients; and
an anti-noise module, configured for processing a newly input time domain reference signal based on the updated time domain adaptive filter coefficients to obtain an anti-noise signal, thereby controlling road noise based on the anti-noise signal.

Besides, in order to achieve the above objective, the present application further provides a device for processing vehicle road noise, including: a memory, a processor, and a computer program stored in the memory and executable on the processor, and the computer program is configured to implement the method for processing vehicle road noise as described above.

Besides, in order to achieve the above objective, the present application further provides a storage medium storing a computer program, and when the computer program is executed by a processor, the method for processing vehicle road noise as described above is implemented.

Besides, in order to achieve the above objective, the present application further provides a computer program product, the computer program product includes a computer program, and when the computer program is executed by a processor, the method for processing vehicle road noise as described above is implemented.

One or more technical solutions proposed in the present application have at least the following technical effects:
the update step size of the sub-band adaptive filter coefficients is dynamically determined based on acquired environmental and/or sensor state information, the sub-band adaptive filter coefficients are updated based on the determined update step size and then converted into time domain adaptive filter coefficients, the time domain adaptive filter coefficients are used to process a time domain reference signal to generate an anti-noise signal, and the anti-noise is then used to control road noise, thereby adapting to changes in environmental conditions inside or outside the vehicle, or to changes in sensor operating conditions, balancing adaptive convergence speed with system stability, which avoids problems such as misjudgment, adverse acoustic effects, and unstable noise reduction caused by overly fast or slow adaptive filter coefficient updates, ensuring system robustness and security, and preventing delayed response or unstable output.

### BRIEF DESCRIPTION OF THE DRAWINGS

The accompanying drawings, which are incorporated into and constitute a part of this specification, illustrate embodiments consistent with the present application and, together with the description, serve to explain the principles of the present application.

To more clearly illustrate the embodiments of the present application or the technical solutions in the related art, the following briefly describes the drawings required for the embodiments or descriptions of the related art. It is obvious that those skilled in the art could derive other drawings based on these drawings without inventive effort.

FIG. 1 is a schematic flowchart of a method for processing vehicle road noise according to an embodiment of the present application.

FIG. 2 is a schematic diagram of a prediction model training process according to an embodiment of the present application.

FIG. 3 is a schematic diagram of a signal processing process according to an embodiment of the present application.

FIG. 4 is a flowchart of a method for processing vehicle road noise according to an embodiment of the present application.

FIG. 5 is a schematic diagram of model architecture and parameter matching architecture according to an embodiment of the present application.

FIG. 6 is a filter coefficient comparison diagram according to an embodiment of the present application.

FIG. 7 is a schematic diagram of the device structure of the hardware operating environment involved in the method for processing vehicle road noise according to an embodiment of the present application.

The objectives, features, and advantages of the present application will be further explained with reference to the accompanying drawings in conjunction with the examples.

### DETAILED DESCRIPTION OF THE EMBODIMENTS

It should be understood that the specific embodiments described herein are intended solely to illustrate the technical solutions of the present application and are not intended to limit the present application.

To better understand the technical solutions of the present application, the following detailed description will be provided in conjunction with the accompanying drawings and specific implementation methods.

Although the existing RNC system has been applied to some mass-produced models, in complex actual application environments, the existing RNC system has insufficient adaptability or poor stability, which can lead to delayed response or unstable output, seriously affecting the driving experience.

In an embodiment of the present application, in order to solve the above technical problem, the update step size of the sub-band adaptive filter coefficients is dynamically determined based on the acquired environmental state information and/or sensor state information, the sub-band adaptive filter coefficients are updated based on the determined update step size, and then the sub-band adaptive filter coefficients are converted into time domain adaptive filter coefficients. The time domain adaptive filter coefficients are used to process the time domain reference signal to generate an anti-noise signal. The anti-noise signal is then used to control road noise, adapting to changes in the vehicle's internal or external environmental conditions, or to changes in sensor operating conditions, which balances adaptive convergence speed with system stability, and avoids problems such as misjudgment, adverse acoustic effects, and unstable noise reduction caused by overly fast or slow adaptive filter coefficient updates, thereby ensuring system robustness and security while preventing delayed responses or unstable outputs.

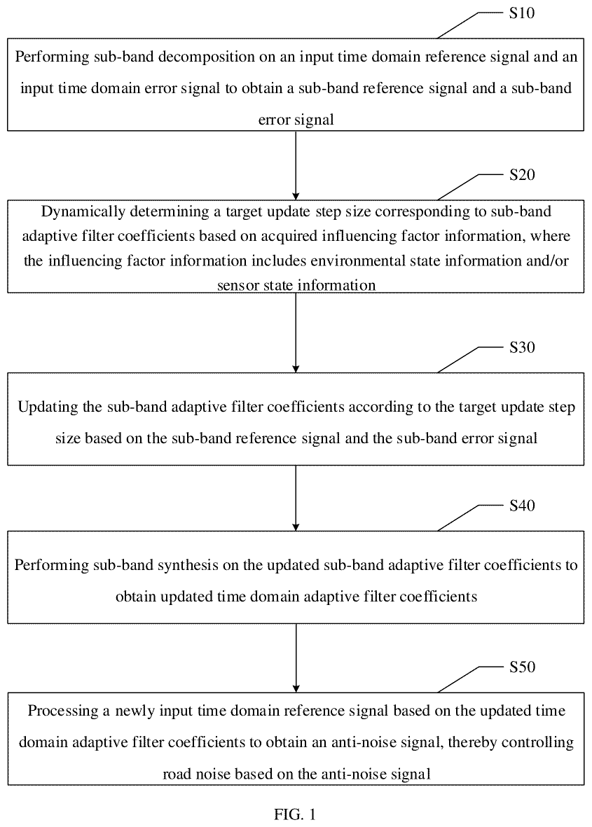

The following presents an embodiment of the method for processing vehicle road noise of the present application. As shown in FIG. 1, FIG. 1 is a schematic flowchart of a method for processing vehicle road noise according to an embodiment of the present application. In this embodiment, the execution subject of the method for processing vehicle road noise may be a control unit in the vehicle's RNC system, but is not limited to a control unit. For example, it may also be a processing device with data processing and program running functions. In one feasible implementation, the vehicle's RNC system may include a sensor, a control unit, a denoiser, and other auxiliary devices as needed. The sensor includes a reference sensor for collecting a reference signal and an error sensor for collecting an error signal, and multiple reference sensors and error sensors may be provided. The reference sensor and the error sensor may be a vibration sensor (accelerometer) or a microphone. The control unit runs adaptive algorithms such as Filtered-x Least Mean Square (FxLMS), Filtered-X Normalized Least Mean Square (FxNLMS), and Filter-x Affine Projection (FxAP), which updates the adaptive filter coefficients based on the reference signal and the error signal and calculates the anti-noise signal. In this embodiment, the method for processing vehicle road noise dynamically adjusts the update step size of the adaptive filter coefficients used in the adaptive algorithm to balance the adaptive convergence speed and system stability, thereby improving the system's adaptability and stability and avoiding problems such as delayed response or unstable output. The denoiser is configured to output an anti-noise signal to offset road noise. In one possible embodiment, the reference sensor may be a vibration sensor, which may be installed at the attachment point between the vehicle body and the chassis. The error sensor may be a microphone, which may be installed inside the vehicle, such as in the roof lining (near the passenger head area). The denoiser may be a vibration actuator and/or a speaker. The vibration actuator generates counter-phase mechanical vibrations based on the anti-noise signal to offset low-frequency road noise transmitted through the vehicle body. The speaker emits counter-phase sound waves based on the anti-noise signal to directly offset airborne noise entering the vehicle cabin (such as the high-frequency components of tire noise).

In this embodiment, the method for processing vehicle road noise includes steps S10 to S50.

Step S10, performing sub-band decomposition on an input time domain reference signal and an input time domain error signal to obtain a sub-band reference signal and a sub-band error signal.

When multiple reference sensors are used, the input time domain reference signal is multi-channel. Similarly, when multiple error sensors are used, the input time domain error signal is also multi-channel. In this embodiment, there is no limit on the number of channels for the time domain reference signal or the time domain error signal. For example, in a Multiple Input Multiple Output (MIMO) vehicle-mounted RNC system, both the input and output are multi-channel.

The time domain reference signal and time domain error signal collected by the sensor can be directly input into the control unit, or input into the control unit after preprocessing. The control unit may directly perform sub-band decomposition on the input time domain reference signal and the time domain error signal, or may perform preprocessing before sub-band decomposition. In this embodiment, there is no restriction on whether or not to preprocess the time domain reference signal and the time domain error signal, nor is there any restriction on what preprocessing is performed on the signal. For example, it may include pre-filtering, amplitude adjustment, etc. Pre-filtering includes high-pass filtering, low-pass filtering, etc., and preprocessing operations can be set as needed. In the following embodiments, the preprocessing operation of the signal is no longer particularly emphasized. That is, even if preprocessing is not written, it does not mean that there is no or no need to perform preprocessing operations.

The control unit performs sub-band decomposition on the time domain reference signal to obtain the sub-band reference signal, and performs sub-band decomposition on the time domain error signal to obtain the sub-band error signal. It is understood that if there are multiple sub-bands, there will also be multiple sub-band reference signals and sub-band error signals obtained through sub-band decomposition. That is, the sub-band reference signal and the sub-band error signal corresponding to each sub-band are obtained through sub-band decomposition. In a specific embodiment, the sub-bands may be obtained by dividing the entire frequency band, but this embodiment is not limited to the full frequency band and may be obtained by dividing a wider frequency range. There is no limit on the number of sub-bands.

In one feasible implementation, the control unit can adopt a method with no output delay to control road noise. That is, the time domain reference signal collected by the reference sensor and the time domain error signal collected by the error sensor are input into the control unit in real time, sampling point by sampling point. The control unit generates a single-sample anti-noise signal in real time based on the current input single-sample time domain reference signal according to the current time domain adaptive filter coefficient, and then outputs the anti-noise signal in real time, achieving the effect of no output delay. On the other hand, the adaptive filter coefficients are updated on a frame-by-frame basis. Specifically, the control unit stores the input time domain reference signal and the input time domain error signal into corresponding buffers in real time. After each frame of the time domain reference signal and the time domain error signal are fully stored, the control unit performs sub-band decomposition on the time domain reference signal and the time domain error signal, and subsequently updates the time domain adaptive filter coefficients. In other implementations, an output delay method may also be employed. That is, the anti-noise signal is not output until the time domain reference signal of multiple sampling points is input. In this embodiment, there is no limitation on whether or not to adopt an output delay method. The specific implementation method can be selected based on the needs of the specific application scenario.

Step S20, dynamically determining a target update step size corresponding to sub-band adaptive filter coefficients based on acquired influencing factor information, where the influencing factor information includes environmental state information and/or sensor state information, the environmental state information is information representing an environmental state inside and/or outside a vehicle, the sensor state information is information representing an operating state of a sensor, and the sensor includes the sensor for collecting the time domain reference signal and/or the sensor for collecting the time domain error signal.

The influencing factor information characterizes the specific performance of influencing factors, which determine the update step size adjustment strategy for the sub-band adaptive filter coefficients. Specifically, the specific performance of these factors determines different update step size adjustment strategies. In this embodiment, the influencing factors may include at least one or more of the following: the environmental conditions inside the vehicle, the environmental conditions outside the vehicle, the operating state of the reference sensor, and the operating state of the error sensor. In other embodiments, other influencing factors may also be included, such as vehicle speed and vibration sensor signal characteristics. These signal characteristics may include acceleration amplitude, energy, and sound pressure signal amplitude.

It should be noted that changes in the external or internal environmental conditions of the vehicle can cause dynamic changes in the acoustic propagation path, which will affect the energy or stability of vehicle road noise, and the impact on the noise energy or stability of different sub-bands is also different. If the update step size of the sub-band adaptive filter coefficients is fixed, when the energy or stability of the vehicle road noise changes, the sub-band adaptive filter coefficients may be updated too quickly due to the update step size being too large, which may lead to system misjudgment or adverse acoustic effects. An excessively small update step size can also lead to slow convergence of the adaptive filter and poor noise reduction. Therefore, in specific implementations, the environmental conditions outside and inside the vehicle can be considered as influencing factors. The update step size can be dynamically adjusted based on these environmental conditions to balance adaptive convergence speed and system stability, avoiding delayed response or unstable output. Changes in the operating state of the reference sensor or the error sensor can affect the accuracy of the acquired signal. For example, if the reference sensor or the error sensor experiences an anomaly, the acquired signal accuracy decreases, leading to an inaccurate estimation of the road noise in the signal. If the sub-band adaptive filter coefficients are updated with a fixed step size, the adaptive filter coefficients will continue to be updated, which will result in the generated anti-noise signal being unable to accurately offset the actual road noise, leading to unstable noise reduction. Therefore, in specific implementations, the operating state of the reference sensor and the operating state of the error sensor can be used as influencing factors. The update step size can be dynamically adjusted based on the operating state of the sensor to balance the adaptive convergence speed and system stability and avoid delayed response or unstable output.

In specific implementations, the environmental state inside the vehicle may include, for example, seat adjustment state, occupant position, window opening and closing state, etc. The environmental state outside the vehicle may include, for example, weather condition, road condition, etc., which are not limited in this embodiment.

In this embodiment, the method for acquiring influencing factor information is not limited. For example, the environmental state information can be obtained by performing image analysis on environmental images captured by a camera, and the sensor state information can be determined by performing outlier analysis on signals collected by the sensor.

The influencing factor information can be acquired at regular intervals, with shorter intervals indicating a higher degree of real-time performance. In this embodiment, the acquisition frequency is not limited. For example, in one feasible implementation, the influencing factor information can be acquired each time the adaptive filter coefficients are updated.

Dynamically determining the update step size of the sub-band adaptive filter coefficients means that after each acquisition of new influencing factor information, the update step size is determined according to the new influencing factor information, so that the update step size of the adaptive filter coefficients changes according to the changes in the specific performance of the influencing factors. The update speed of the adaptive filter coefficients is adjusted by dynamically adjusting the update step size to adapt to changes in the environmental conditions inside or outside the vehicle, or to changes in the operating state of the sensor, to balance the adaptive convergence speed and system stability, and to avoid misjudgment, adverse acoustic effects, unstable noise reduction effects, and other problems caused by the update speed of the adaptive filter coefficients being too fast or too slow, thereby ensuring the robustness and safety of the system and avoiding delayed response or unstable output.

The specific method for determining the update step size of the sub-band adaptive filter coefficients based on the influencing factor information is not limited in this embodiment. For example, a mapping relationship between the influencing factor information and the update step size of the sub-band adaptive filter coefficients can be predetermined as needed. After obtaining the influencing factor information, the control unit uses the update step size corresponding to the influencing factor information as the target update step size based on the mapping relationship. In this embodiment, the mapping relationship is not limited. For example, the mapping relationship can be expressed in a mapping table, a relational expression, or the like. The mapping relationship can also be determined through experiments, statistical data, or other methods.

It should be noted that, since there are multiple sub-bands, there are multiple sub-band adaptive filters. The target update step sizes of the sub-band adaptive filters coefficients may be the same or different, which is not limited in this embodiment.

Step S30, updating the sub-band adaptive filter coefficients according to the target update step size based on the sub-band reference signal and the sub-band error signal.

After determining the target update step size, the sub-band adaptive filter coefficients can be updated according to a predetermined adaptive algorithm. For example, the adaptive algorithm can employ FxLMS, FxNLMS, or FxAP, which is not limited in this embodiment.

For example, in one feasible implementation, the adaptive algorithm can employ a complex-domain FxLMS algorithm. Specifically, the control unit may convolve the sub-band reference signal with a pre-established secondary path model. The control unit then employs a complex-domain LMS algorithm based on the sub-band error signal, the sub-band reference signal after convolution with the secondary path model, and the current sub-band adaptive filter coefficients to calculate the updated sub-band adaptive filter coefficients.

Step S40, performing sub-band synthesis on the updated sub-band adaptive filter coefficients to obtain updated time domain adaptive filter coefficients.

In order to avoid output delay, filtering output must be performed in the time domain (full frequency band), so the sub-band adaptive filter coefficients can be converted to the full frequency band. By performing sub-band synthesis on the updated sub-band adaptive filter coefficients, the updated time domain adaptive filter coefficients can be converted.

It should be noted that this embodiment employs a sub-band adaptive algorithm. Specifically, the sub-band adaptive filter coefficients are updated separately and then synthesized into the full-band (time domain) adaptive filter coefficients. Compared to directly updating the full-band (time domain) adaptive filter coefficients, this embodiment updates each sub-band adaptive filter coefficient separately according to its corresponding target update step size, and then synthesizes the updated sub-band adaptive filter coefficients into the updated time domain adaptive filter coefficients, which has the advantages of fast convergence, independence of different sub-bands, and the ability to use different adaptive algorithms and filter orders for different sub-bands. Furthermore, it is less sensitive to input signal variations.

In this embodiment, the algorithms used for sub-band decomposition and sub-band synthesis are not limited and can be selected as needed. For example, in one feasible implementation, the Uniform Discrete Fourier Transform Model (UDFTM) method can be used to perform sub-band decomposition on the time domain reference signal and the time domain error signal, respectively, and the sub-band filter coefficients can be restored to the full frequency band using a weight stacking technique. For another example, in another feasible implementation, a polyphase analysis filter bank can be used for sub-band decomposition, and a polyphase synthesis filter bank can be used for sub-band synthesis.

Step S50, processing a newly input time domain reference signal based on the updated time domain adaptive filter coefficients to obtain an anti-noise signal, thereby controlling road noise based on the anti-noise signal.

After the time domain adaptive filter coefficients are updated, the newly input time domain reference signals can be processed according to the updated time domain adaptive filter coefficients to generate an anti-noise signal. After generating the anti-noise signal, road noise can be controlled based on the anti-noise signal. For example, the anti-noise signal can be played through the speaker installed inside the vehicle. Alternatively, the anti-noise signal can be subjected to some post-processing before being output. The post-processing operation can include amplitude limitation, which is not limited herein.

The generated anti-noise signal may be multi-channel. For example, when there are multiple speakers, the multi-channel anti-noise signal may be generated and output through the multiple speakers. In this embodiment, the number of channels of the anti-noise signal is not limited.

In this embodiment, the update step size of the sub-band adaptive filter coefficients is dynamically determined based on acquired environmental and/or sensor state information, the sub-band adaptive filter coefficients are updated based on the determined update step size and then converted into time domain adaptive filter coefficients, the time domain adaptive filter coefficients are used to process a time domain reference signal to generate an anti-noise signal, and the anti-noise is then used to control road noise, thereby adapting to changes in environmental conditions inside or outside the vehicle, or to changes in sensor operating conditions, balancing adaptive convergence speed with system stability, which avoids problems such as misjudgment, adverse acoustic effects, and unstable noise reduction caused by overly fast or slow adaptive filter coefficient updates, ensuring system robustness and security, and preventing delayed response or unstable output.

In one feasible implementation, in order to improve the noise reduction effect of the system and ensure the stability of noise reduction, the control unit is configured to dynamically determine the target update step size based on the influencing factor information in accordance with one or more of the following rules:

1. Under the environmental state represented by the environmental state information, the target update step size corresponding to the sub-band with higher vehicle road noise energy or higher stability is larger than the target update step size corresponding to the sub-band with lower vehicle road noise energy or lower stability.

Under the same environmental conditions, the distribution of road noise across different sub-bands may vary. For sub-bands with higher noise energy, a larger update step size can be used to specifically enhance the noise reduction strength in those sub-bands, improving the noise reduction effect and avoiding delayed response. For sub-bands with lower noise energy, a smaller update step size can be used to ensure the stability of the noise reduction effect and avoid unstable output. Under the same environmental conditions, the stability of road noise in different sub-bands may vary. For sub-bands with higher stability, a larger update step size can be used to ensure faster adaptive convergence and lower steady-state error, thus avoiding delayed response. For sub-bands with lower stability, a smaller update step size can be used to avoid misjudgments or adverse acoustic effects, thereby ensuring system robustness and safety.

It should be noted that the stability of vehicle road noise refers to the stability of noise energy changes.

2. For any target sub-band, the higher the energy or the higher the stability of the vehicle road noise in the target sub-band under the environmental conditions represented by the environmental state information, the larger the target update step size corresponding to the target sub-band. The lower the energy or the lower the stability of the vehicle road noise in the target sub-band under the environmental conditions represented by the environmental state information, the smaller the target update step size corresponding to the target sub-band.

For the same sub-band, the energy of road noise may vary under different environmental conditions. Therefore, for a specific sub-band (referred to as the target sub-band for distinction), if the energy of road noise in the target sub-band is higher under certain environmental conditions, a larger update step size can be used for the target sub-band to specifically enhance the noise reduction strength in that sub-band, to improve the noise reduction effect, and avoid delayed response. If the energy of road noise in the target sub-band is lower under certain environmental conditions, a smaller update step size can be used for the target sub-band to ensure the stability of the noise reduction effect. For the same sub-band, the stability of road noise in that sub-band may vary under different environmental conditions. Therefore, for a specific sub-band (referred to as the target sub-band for distinction), if the road noise in the target sub-band is highly stable under certain environmental conditions, a larger update step size can be used for the target sub-band to ensure faster adaptive convergence and lower steady-state error, thus avoiding delayed response. If the road noise energy in the target sub-band is low under certain environmental conditions, a smaller update step size can be used for the target sub-band to avoid system misjudgments or adverse acoustic effects, thereby ensuring system robustness and safety.

3. Based on the abnormality degree of each sensor represented by the sensor state information, the target update step size corresponding to the sub-band where the sensor with a higher abnormality degree is located is smaller than the target update step size corresponding to the sub-band where the sensor with a lower abnormality degree is located.

The sub-band where the sensor is located refers to the sub-band where the signals collected by the sensor are distributed or mainly distributed. Different sensors may have different sub-bands.

The sensor state information represents the operating state of the sensor. In specific embodiments, the operating state of the sensor can be divided into two types: normal operation and abnormal operation. The sensor state information can be information indicating whether the sensor is in a normal operating state or an abnormal operating state. It can be understood that the abnormality level of the sensor in the “normal operating” state is lower than the abnormality level of the sensor in the “abnormal operating” state. Alternatively, the operating state of the sensor can be divided into more than two types, for example, using a value between 0 and 1 to represent different abnormality levels. The sensor state information can be a numerical value indicating the abnormality level of the sensor.

Based on the acquired sensor state information, the abnormality level of each sensor can be determined, which may vary from sensor to sensor. For sensor with higher abnormality level, a smaller update step size can be used for the sub-band in which the sensor resides to avoid misjudgments and adverse acoustic effects. For sensor with lower abnormality level, a larger update step size can be used for the sub-band in which the sensor resides to ensure effective noise reduction and avoid delayed responses.

4. For any target sub-band, the higher the abnormality level of the sensor in the target sub-band, the smaller the target update step size corresponding to the target sub-band; the lower the abnormality level of the sensor in the target sub-band, the larger the target update step size corresponding to the target sub-band.

For a certain sub-band (hereinafter referred to as a target sub-band for distinction), the sensors belonging to the target sub-band refer to sensors whose signals are all or mainly distributed in the sub-band.

For a target sub-band, the abnormality level of the sensor in the target sub-band may vary depending on the sensor state information obtained. If the abnormality level of the sensor in the target sub-band is higher, a smaller update step size can be used for the target sub-band to avoid system misjudgments and adverse acoustic effects. If the abnormality level of the sensor in the target sub-band is lower, a larger update step size can be used for the target sub-band to ensure system noise reduction and avoid delayed responses.

In one feasible implementation, the influencing factor information may also include the vehicle's real-time speed. Vehicle speed changes can affect the energy level or stability of the vehicle's road noise. If a fixed step size is used to update the sub-band adaptive filter coefficients when the vehicle speed changes, this could lead to misjudgment or adverse acoustic effects due to excessively large update steps and overly rapid updates of the sub-band adaptive filter coefficients when the energy level or stability of the vehicle's road noise changes. Therefore, vehicle speed can be considered as an influencing factor.

In one feasible implementation, when the influencing factor information also includes vehicle speed, the target update step size may be dynamically determined based on the influencing factor information, and may also comply with one or more of the following rules:

5. The higher the vehicle speed stability, the larger the target update step size corresponding to each sub-band. The lower the vehicle speed stability, the smaller the target update step size corresponding to each sub-band.

For example, vehicle speed stability refers to the rate of change of vehicle speed. A higher rate of change indicates lower speed stability, while a lower rate of change indicates higher speed stability.

Higher speed stability leads to higher road noise stability. In this case, using a larger update step size can ensure faster adaptive convergence and lower steady-state error, thus avoiding delayed response. Lower speed stability leads to lower road noise stability. In this case, using a smaller update step size can avoid system misjudgments or adverse acoustic effects, thus ensuring system robustness and safety.

6. When the vehicle speed is outside the preset range, the target update step size for each sub-band is smaller than the target update step size for each sub-band when the vehicle speed is within the preset range.

The preset range indicates a normal vehicle speed. When the vehicle speed is outside the preset range, it indicates an extreme or abnormal situation. Road noise may exhibit extreme or abnormal characteristics. For such extreme or abnormal situations, a smaller update step size may be used to avoid misjudgments or adverse acoustic effects.

In one feasible implementation, the step S20 includes: determining an update step length corresponding to the influencing factor information as a target update step length according to a preset mapping relationship, where the mapping relationship satisfies one or more of the above rules.

In a specific implementation, in order to ensure that the control unit complies with one or more of the above rules when dynamically determining the target update step based on the influencing factor information, a mapping relationship that satisfies one or more of the above rules can be set. The control unit determines the update step corresponding to the influencing factor information as the target update step based on the mapping relationship. The mapping relationship can be expressed through a mapping table, a relational expression, etc. It should be noted that when the settings need to comply with multiple rules above, the multiple rules can comply with a certain priority order to avoid conflicts. The priority order can be set specifically as needed and is not limited here. For example, the priority of determining the update step size based on the sensor state information may be higher than the priority of determining the update step size based on the environmental state information.

In one feasible implementation, the environmental state information includes weather condition information and road condition information. The weather condition information may specifically represent weather conditions that affect the road surface, such as road dryness, rainfall, and humidity. The road condition information may specifically represent the type of road surface, such as asphalt, potholes, or bricks.

In one feasible implementation, when the environmental state information and the sensor state information indicate that the environment is good and stable (for example: good road conditions, clear weather, normal sensors, and moderate vehicle speed), the vehicle road noise is relatively stable, and there is no particularly abnormal noise in each sub-band. At this time, a moderate or large update step size can be used to ensure the system's adaptive convergence speed and a low steady-state error level. When the environmental state information and the sensor state information indicate that the environment is deteriorating or unstable (for example, road conditions are deteriorating, weather is bad, sensors are abnormal, and vehicle speed changes dramatically), the vehicle road noise may become less stable. At this time, a smaller update step size can be used to improve system stability. When the environmental state information and the sensor state information indicate the presence of specific noise types (e.g., flooded roads, brick pavement, wind noise), the step sizes of different frequency sub-bands can be adjusted differently. The sub-bands with high noise energy use larger update steps, specifically increasing or decreasing filtering strength in specific frequency bands to optimize noise reduction. When the environmental state information and the sensor state information indicate extremely harsh conditions or system anomalies (e.g., extremely poor road conditions, severe sensor failure, or extremely low speeds), the update step size can be significantly reduced or even frozen to avoid system misjudgments or adverse acoustic effects, ensuring system robustness and safety.

Table 1 below provides some examples of determining the update step size for the low, mid, and high frequency bands based on weather information, road condition information, sensor state information, and vibration sensor signal characteristics (acceleration amplitude, energy, and sound pressure signal amplitude). The low, mid, and high frequency bands can be divided as needed. It is understood that each of the three frequency bands contains one or more sub-bands. Table 1 provides only some examples and does not limit the method for determining the target update step size in this embodiment. The information in brackets in the table explains the weather information, road condition information, sensor state information, and update step size.

TABLE 1
Example of update step selection

| Road Condition | Weather Condition | | Update Step Size |
|---|---|---|---|
| Examples | Examples | Sensor State Examples | Examples |
| Smooth asphalt road, | Wet and slippery | A11 sensors working | Low-frequency |
| confidence >90% | accumulation | normally, confidence | update step: 0.05; |
| | (rainy day or water | >90%, vibration sensor | Mid-frequency |
| | accumulation | acceleration amplitude | update step: 0.03; |
| | section, rainfall | <0.02 g, energy <0.01 g² · s, | High-frequency |
| | about 5 mm/h), | sound pressure signal | update step: 0.02. |
| | confidence >90%. | amplitude <65 dB(A) | (Increase low- |
| | | (mainly low-frequency | frequency sub-band |
| | | components). | step to enhance |
| | | | suppression of water |
| | | | accumulation low- |
| | | | frequency rolling |
| | | | noise, maintain |
| | | | medium update |
| | | | steps for mid and |
| | | | high frequencies) |
| Smooth asphalt road, | Dry and sunny | Error microphone | Low-frequency |
| confidence >85% | (temperature 25 °C, | abnormal operation (e.g., | update step: 0.03; |
| | humidity 20%), | slight blockage), | Mid-frequency |
| | confidence >80%. | confidence >90%, | update step: 0.02; |
| | | vibration sensor | High-frequency |
| | | acceleration amplitude | update step: 0.02. |
| | | <0.04 g, energy | (Maintain medium |
| | | <0.015 g² · s, sound | steps for all sub- |
| | | pressure signal amplitude | bands, reduce step |
| | | <65 dB(A) (overall | by 15% for the sub- |
| | | stable). | band with blocked |
| | | | microphone) |
| Potholed road | Dry or slightly wet, | Vibration | Low-frequency |
| (uneven), confidence | confidence >80% | sensor | update step: 0.01; |
| >80% | | abnormal operation | Mid-frequency |
| | | (overshoot or low | update step: 0.04; |
| | | distortion), confidence | High-frequency |
| | | >60%, vibration sensor | update step: 0.05. |
| | | acceleration amplitude | (Quickly track high- |
| | | <1 g (with short-term | frequency noise |
| | | impacts), energy | components or main |
| | | <0.04 g² · s, sound pressure | path changes) |
| | | signal amplitude | |
| | | <65 dB(A). | |
| Brick road, | Dry, confidence | Sensors working | Low-frequency |
| confidence >90% | >80% | normally, confidence | update step: 0.02; |
| | | >80%, vibration sensor | Mid-frequency |
| | | acceleration amplitude | update step: 0.03; |
| | | <0.02 g, energy | High-frequency |
| | | <0.015 g² · s, sound | update step: 0.02. |
| | | pressure signal amplitude | (Increase mid- |
| | | <65 dB(A), mainly mid- | frequency sub-band |
| | | frequency characteristics. | step to enhance mid- |
| | | | frequency noise |
| | | | suppression, |
| | | | medium steps for |
| | | | low and high |
| | | | frequencies) |
| Ordinary asphalt road | Slightly wet, | Sensors working | Low-frequency |
| (medium | confidence >70% | normally, confidence | update step: 0.02; |
| smoothness), | | >80%, vibration sensor | Mid-frequency |
| confidence >85% | | acceleration amplitude | update step: 0.02; |
| | | <0.03 g, energy <0.02 g² · s, | High-frequency |
| | | sound pressure signal | update step: 0.02. |
| | | amplitude <45 dB(A) | (Balanced steps, no |
| | | (mostly mid-to-low | specific |
| | | frequency components). | enhancement or |
| | | | suppression) |
| Cement road (hard | Dry, confidence | Error microphone | Low-frequency |
| ground), confidence | >65% | abnormal operation (wind | update step: 0.03; |
| >80% | | noise interference), | Mid-frequency |
| | | confidence >70%, | update step: 0.03; |
| | | vibration sensor | High-frequency |
| | | amplitude <0.04 g, | update step: 0.01. |
| | | medium energy, sound | (Slightly increase |
| | | pressure signal amplitude | mid-to-low |
| | | <50 dB(A) | frequency sub-band |
| | | | steps to handle |
| | | | cement road noise, |
| | | | slightly reduce high- |
| | | | frequency sub-band |
| | | | step to mitigate wind |
| | | | noise impact) |
| Unknown/composite | water | Error microphone | Low-frequency |
| road (uncertain | accumulation, | abnormal operation | update step: 0.01; |
| structure, other | confidence >65% | (possible partial | Mid-frequency |
| categories), | | blockage), vibration | update step: 0.01; |
| confidence >60% | | sensor signal fluctuates | High-frequency |
| | | greatly, amplitude <1 g but | update step: 0.01. |
| | | unstable, sound pressure | (Reduce step for |
| | | signal amplitude | severely blocked |
| | | <55 dB(A) (frequency | sub-bands, flexibly |
| | | distribution uncertain). | adjust other sub- |
| | | | bands to quickly |
| | | | adapt to unknown |
| | | | characteristics) |
| Extreme interference | Uncertain, all | Error | Low-frequency |
| conditions (all error | category | microphones/vibration | update step: 0.01; |
| mics severely | confidences <55% | sensors all abnormal | Mid-frequency |
| abnormal), all | | operation (distortion, | update step: 0.01; |
| category confidences | | highly likely blockage or | High-frequency |
| <60% | | excessive noise), | update step: 0.01. |
| | | vibration sensor | (Significantly |
| | | amplitude >2 g, energy | reduce or freeze all |
| | | >0.1 g² · s, sound pressure | sub-band update |
| | | signal amplitude | steps to prevent |
| | | >70 dB(A). | exacerbation of |
| | | | erroneous |
| | | | compensation) |

Based on the above embodiment described above, the present application provides another embodiment of the method for processing vehicle road noise. In this embodiment, the same or similar contents as those of the above embodiment can be referred to above and will not be further elaborated. In this embodiment, a prediction model is proposed for predicting the environmental state information and/or the sensor state information based on an input reference signal and an error signal. Specifically, in this embodiment, the method for processing vehicle road noise further includes step S60: using a preset prediction model to predict the environmental state information and/or the sensor state information based on the input time domain reference signal, the input time domain error signal, the sub-band reference signal, and the sub-band error signal, the prediction model is pre-trained.

In a specific embodiment, the prediction model can be implemented using a neural network model, which can be pre-trained and deployed in the control unit. The control unit calls the prediction model to perform predictions when it needs to obtain the environmental state information or the sensor state information. In this embodiment, there is no limitation on the implementation method of the prediction model.

In a specific implementation, multiple prediction models may be provided to output different environmental state information or sensor state information respectively, or one prediction model may be provided to output multiple types of information in a multi-output task mode.

In this embodiment, since changes in environmental conditions and sensor states are reflected in the signals collected by the sensors, the time domain reference signal, the time domain error signal, the sub-band reference signal, and the sub-band error signal are used as input data for the prediction model. The pre-trained prediction model can learn the relationship between these input data and the environmental state information or the sensor state information. Furthermore, the prediction model can be used to predict the environmental state information or the sensor state information based on these input data. On the one hand, by obtaining the environmental state information or the sensor state information through model prediction, existing reference signals and error signals can be used without the need for additional data acquisition modules. On the other hand, the complexity of vehicle road noise under different environmental conditions or sensor conditions can be reflected in the signals collected by the sensors. Therefore, the signals collected by the prediction model sensors can predict more complex and accurate environmental state information and sensor state information, and then dynamically determine the update step size of the sub-band adaptive filter based on this information, which can greatly improve the system's ability to cope with complex environments. In addition, using time domain signals and sub-band signals as the prediction basis, taking into account the importance of frequency domain features, can accurately detect and match more scenarios with small differences in time domain features.

In one feasible implementation, the prediction model may include a first feature extraction module, a second feature extraction module, a third feature extraction module, a feature fusion module, and a prediction module. The step S60 includes S601 to S605:

Step S601, inputting the sub-band reference signal and the sub-band error signal into the first feature extraction module for feature extraction to obtain a first feature representation.

Step S602, inputting the input time domain reference signal into the second feature extraction module for feature extraction to obtain a second feature representation.

Step S603, inputting the input time domain error signal into the third feature extraction module for feature extraction to obtain a third feature representation.

Step S604, concatenating the first feature representation, the second feature representation, and the third feature representation and inputting into the feature fusion module for feature fusion to obtain a fused feature representation.

Step S605, inputting the fused feature representation into the prediction module for prediction to obtain the environmental state information and/or the sensor state information.

It should be noted that in order to improve the accuracy of the prediction results and fully mine the information related to the environmental state and the sensor state in the signal, in this embodiment, feature extraction modules are set for the sub-band reference signal and the sub-band error signal, the time domain reference signal, and the time domain error signal, respectively, to extract the signal features of the three signals. For the sake of distinction, they are respectively called the first feature extraction module, the second feature extraction module, and the third feature extraction module; this can be implemented using a feature extraction module based on a neural network structure. The outputs of the three feature extraction modules are known as feature representations, which are referred to as the first feature representation, the second feature representation, and the third feature representation for clarity. The feature representations can take the form of feature vectors or feature maps, which are not limited in this embodiment. The feature fusion module can be a module for simply concatenating the three feature representations, or can also include a module for deep fusion of the concatenated features. The deep fusion module can also be implemented based on a neural network architecture, which is not limited here. The prediction module can be designed based on the type of information to be output and the specific form of each information, which is not limited in this embodiment.

In one feasible implementation, the first feature extraction module, the second feature extraction module, and the third feature extraction module each include at least one convolutional layer, which extracts features from the signal. The feature fusion module includes a sequentially connected frequency-gated recurrent unit (FGRU), a time-gated recurrent unit (TGRU), and at least one transposed convolutional layer. The frequency-gated recurrent unit processes data along the frequency axis to capture correlations in the frequency dimension. The time-gated recurrent unit processes the output of the frequency-gated recurrent unit along the time axis to capture dynamic features in the time dimension. The transposed convolutional layer gradually upsamples and restores the data to its original size. The prediction module includes multiple task output layers, each of which outputs the environmental state information or the sensor state information. Hereinafter, the FGRU and TGRU may also be collectively referred to as FT-GRU.

In one feasible implementation, a prediction model based on a modified U-Net (a deep learning-based convolutional neural network) architecture, integrating frequency-gated recurrent units and time-gated recurrent units, is designed specifically for processing complex acoustic and vibration signals. This prediction model includes an encoder and a decoder, specifically designed to process acoustic and vibration signals. The encoder uses multiple layers of convolution, batch normalization, and ReLU activation functions to perform step-by-step downsampling to effectively extract features. The decoder uses multiple layers of transposed convolution and skip connections to perform step-by-step upsampling to prepare features for on-device classification tasks. Furthermore, the network architecture integrates FGRU and TGRU to enhance its processing capabilities for multidimensional data, particularly in time series and frequency analysis, to adapt to real-time changing environmental conditions. This comprehensive design not only captures complex spatial features but also dynamically adjusts GRU layer responses, improving the model's adaptability and prediction accuracy to complex changes in both the vehicle's interior and exterior environments. Specifically, the encoder includes the first feature extraction module, the second feature extraction module, and the third feature extraction module. The first feature extraction module may include three convolutional layers. The first two convolutional layers are each followed by a maximum pooling layer. The third convolutional layer adjusts the dimensionality of the output feature representation to facilitate concatenation of the feature representation output by the first feature extraction module with the feature representations output by the other two feature extraction modules. The dimensions of the input and output data of the first feature extraction module, as well as the dimensions of the input and output data of its convolutional and maximum pooling layers, can be adjusted as needed and are not limited here. The second feature extraction module and the third feature extraction module perform feature extraction on time domain signals and can each include a one-dimensional convolutional layer, a pooling layer, and a convolutional layer for adjusting the dimensionality of the output feature representation. The dimensions of the input and output data of the second feature extraction module and the third feature extraction module, as well as the dimensions of the input and output data of their convolutional and pooling layers, can be customized as needed and are not limited here. The feature representations output by the three feature extraction modules are concatenated and then fed into a frequency-gated recurrent unit (GRU). This concatenation can be done, for example, along the channel dimension, though this is not a limitation. The GRU processes data along the frequency axis and captures correlations along the frequency dimension. The concatenated feature representations are divided into multiple time steps and fed sequentially into the GRU. After a recursive computation, the GRU outputs the hidden state corresponding to each time step, which is then fed sequentially into the GRU. The time-gated recurrent unit processes the output of the frequency-gated recurrent unit along the time axis, capturing dynamic features in the temporal dimension. The time-gated recurrent unit cyclically computes the hidden state of each input time step, and the output further serves as the input to the transposed convolutional layer. There are no restrictions on the input and output dimensions of the frequency-gated recurrent unit and the time-gated recurrent unit. The decoder following the timeline gated recurrent unit can be configured to include two transposed convolutional layers and one convolutional layer for adjusting the dimension of the output data. The dimensions of the specific input and output data are not limited here. The decoder is followed by a multi-task output layer. The multi-task output layer can include a shared feature extraction layer and output layers for each type of information. For example, if you need to output weather conditions, road conditions, and sensor state information, you can have separate output layers for each type of information. The shared feature extraction layer can include one or more convolutional layers, followed by a pooling layer to extract common features and reduce spatial dimensionality. The output layer for each piece of information can include a convolutional layer, a global average pooling layer, and a fully connected layer. An activation function is provided after the fully connected layer to output the confidence level or probability distribution corresponding to each value category of each piece of information, which is used to determine the final value of each piece of information. The dimensions of the input and output data of the multi-task output layer and the dimensions of the input and output data of each layer within it are also unrestricted. This implementation not only ensures independent processing of each task, but also optimizes the overall performance and resource utilization of the model by sharing underlying features and specializing top-level decisions.

In one feasible implementation, a lightweight, real-time, low-parameter frequency-time U-Net network can be used as the prediction model. This network is specifically designed to accurately process and analyze multiple frequency and time domain data, ensuring the effective fusion of multi-source information from the sub-band and time domains. This significantly improves the recognition speed and accuracy of complex acoustic environments and road conditions, and enhances the model's robustness to changes in the vehicle's internal and external environments. Specifically, the dimensions of the prediction model's input and output data, as well as the input and output data of each layer within the model, can all conform to the definitions of [batch size, feature dimension, number of channels]. The input data dimensions for the first feature extraction module can be set to [1, 65, 11]. A batch size of 1 indicates that a single sample is processed at a time. The feature dimension is 65, corresponding to the frequency domain features extracted by sub-band analysis (i.e., 65 sub-bands). The number of channels is 11, including 9 vibration sensor channels and 2 error microphone channels. The input data dimensions for the second feature extraction module can be set to [1, 64, 9]. A batch size is 1, and a time step of 64 indicate the time domain signal length (i.e., a frame length of 64). The number of channels is 9, corresponding to 9 vibration sensors. The input data for the third feature extraction module is set to [1, 64, 2] with a batch size of 1, a time step of 64, and a channel count of 2, corresponding to two error microphones. When training the prediction model, a sequence of T frames can be input, for example, [1, T, 65, 11], allowing the FT-GRU to learn inter-frame relationships. During inference, the input is frame by frame, and the FT-GRU implements inter-frame modeling through state transfer.

The encoder includes a first feature extraction module, a second feature extraction module, and a third feature extraction module.

The first feature extraction module may include:

First convolution layer: the convolution kernel dimension is 3×3, the number of input channels is 11, the number of output channels is 16, the padding is 1 (“same” padding), and the output dimension is [1, 65, 16].

Max pooling layer: the pooling window is 2×1, the step size is 2, and the output dimension is [1, 32, 16].

Second convolution layer: the convolution kernel dimension is 3×3, the number of input channels is 16, the number of output channels is 32, the padding is 1 (“same” padding), and the output dimension is [1, 32, 32].

Max pooling layer: the pooling window is 2×1, the step size is 2, and the output dimension is [1, 16, 32].

1D Convolution Layer: 1D convolution, the kernel dimension is 4×1, the number of input channels is 32, the number of output channels is 32, step size is 2×1, the padding is valid, and the output dimension is [1, 29, 32].

The first feature extraction module has a final output dimension of [1, 29, 32].

The second feature extraction module includes:

1D Convolution Layer: the convolution kernel dimension is 3, the number of input channels is 9, the number of output channels is 16, the padding is 1 (“same” padding), and the output dimension is [1, 64, 16].

Pooling Layer: the pooling window is 2, the step size is 2, and the output dimension is [1, 32, 16].

1D Convolution Layer: 1D Convolution, the convolution kernel dimension is 4, the number of input channels is 16, the number of output channels is 32, the step size is 1, the padding is “valid”, and the output dimension is [1, 29, 32].

The third feature extraction module includes the following:

1D convolution layer: the convolution kernel dimension is 3, the number of input channels is 2, the number of output channels is 32, the step size is 1 (“same” padding), and the output dimension is [1, 64, 32].

Pooling layer: the pooling window is 2, the step size is 2, and the output dimension is [1, 32, 32].

1D convolution layer: 1D convolution, the convolution kernel dimension is 4, the number of input channels is 32, the number of output channels is 32, the step size is 1, the padding is “valid”, and the output dimension is [1, 29, 32].

Splicing operation in the feature fusion stage: the outputs of all three branches are [1, 29, 32], which are concatenated along the channel dimension, i.e., 32+32+32=96, resulting in an output dimension of [1, 29, 96].

The encoder is followed by the FT-GRU layer, which has an input dimension of [1, 29, 96], where 29 represents the feature dimension (or time step) and 96 represents the number of input feature channels. The FT-GRU layer includes:

The first layer: Freq GRU (Frequency-Oriented GRU). Its function is to process data along the frequency axis and capture correlations along the frequency dimension. The input dimensions are [1, 29, 96], where 29 represents the time step and 96 represents the feature channel dimension. Processing: For each time step (29 in total), the Freq GRU treats the 96-dimensional features as an input sequence (length 96), performs recursive computations, and outputs hidden states. Assuming the number of hidden units is H (for example, H=32), the output is [1, 29, H].

The second layer: the Time GRU (GRU on the time axis). Its function is to process the output of the Freq GRU along the time axis to capture dynamic features in the temporal dimension. The input dimension is [1, 29, H]. The processing method is to loop over 29 time steps, inputting H-dimensional features at each time step and outputting the final features. Assuming the target number of output channels is 32, the output dimension is [1, 29, 32].

The decoder following the FT-GRU layer consists of two transposed convolutional layers and one convolutional layer to reshape the output data.

The first transposed convolutional layer has an input dimension of [1, 29, 32], a transposed kernel size of 4×1, a step size of 2, padding of 1, 32 output channels, and an output dimension of [1, 58, 32].

The second transposed convolutional layer has an input dimension of [1, 58, 32], an transposed kernel size of 8×1, a step size of 1, padding of 0, 16 output channels, and an output dimension of [1, 65, 16].

The third transposed convolutional layer has an input dimension of [1, 65, 16], an transposed kernel size of 1×1, a step size of 1, 1 output channel, and an output dimension of [1, 65, 1].

The decoder is followed by a multi-task output layer, which consists of a shared feature extraction layer and multiple output layers (road condition classification branch, weather condition classification branch, and sensor state monitoring branch).

The shared feature extraction layer has an input dimension of [1, 65, 1] and includes:

Convolutional layer: kernel size 3×1, 1 input channel, 32 output channels, padding 1 (“same” padding), output [1, 65, 32]. Max pooling layer: pooling window 2×1, step size 2, output [1, 32, 32]. This layer extracts common features and reduces spatial dimensionality.

Following the shared feature extraction layer are the road condition classification branch, the weather condition classification branch, and the sensor state monitoring branch.

The road condition classification branch has an input dimension of [1, 32, 32] and an output dimension of [1, N], representing the probability distribution of N road conditions. The road condition classification branch includes the following:

Convolutional layer: 1×1 convolution, 64 output channels, and an output dimension of [1, 32, 64].

Global average pooling: Dimensionality reduction to [1, 64].

Fully connected layer: Outputs N (number of road condition categories), activation function Softmax.

The weather condition classification branch has an input dimension of [1, 32, 32] and an output dimension of [1, M], representing the probability distribution of M weather conditions. The weather condition classification branch includes:

Convolutional layer: 1×1 convolution, 64 output channels, and an output dimension of [1, 32, 64].

Global average pooling: Dimensionality reduction to [1, 64].

Fully connected layer: Outputs M (the number of weather condition categories), activation function Softmax.

The sensor state monitoring branch has an input dimension of [1, 32, 32] and an output dimension of [1, 11]. Each value ranges from 0 to 1, representing the confidence level of the 11 sensors. The sensor state monitoring branch includes:

Convolutional layer: 1×1 convolution, 128 output channels, and an output dimension of [1, 32, 128].

Global average pooling: Dimensionality reduction to [1, 128].

Fully connected layer: Output 11 (corresponding to 11 sensors), activation function Sigmoid.

Overall, the prediction model outputs the following:

Road condition classification: [1, N], probability distribution of N road conditions.

Weather condition classification: [1, M], probability distribution of M weather conditions.

Sensor state monitoring: [1, 11], confidence levels (0-1) of the 11 sensors.

Based on the above-mentioned results output by the prediction model, the road condition information representing the road condition, the weather condition information representing the weather condition, and the sensor state information representing the sensor state can be derived. For example, in one feasible implementation, the category corresponding to the highest probability distribution among the various probability distributions in the road condition classification results can be used as the road condition information. Another example is that the confidence level in the sensor state monitoring results can be predetermined to indicate the degree of sensor abnormality. The sensor state information can be binary information indicating whether the sensor is in a normal or abnormal state, or information indicating the degree of sensor abnormality. This can be determined as needed in specific implementations.

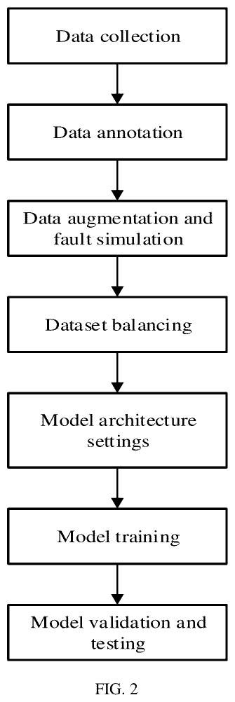

In one possible implementation, as shown in FIG. 2, the prediction model can be pre-trained using the following method.

Step 1: Data Collection. Accelerometers and microphones with sensitivity and frequency response that meet test requirements are installed at the required locations on the vehicle to comprehensively capture vibration and sound data under various road conditions and speeds.

Step 2: Data Annotation. Annotation can be completed simultaneously during data recording. All data annotation can be performed directly by annotators during data recording, providing real-time, detailed annotation of road conditions in the data. Specifically, as microphones and vibration sensors collect data from inside and outside the vehicle, annotators instantly categorize and describe the current road conditions. For example, these descriptions may include, but are not limited to, road type (e.g., highway, urban road, rural road), lane markings, road surface texture, potholes, obstacle distribution, and road slipperiness. Annotators also record and annotate weather conditions that may affect road conditions (e.g., rain or snow).

Step 3: Data Augmentation. To improve the model's ability to detect anomalies, artificial sensor failures and noise can be introduced. First, enhance the model's robustness by simulating various sensor failures and environmental disturbances. For example, covering the microphone with cloth, plastic, or metal sheets can simulate dust and water blockage, and tapping the accelerometer can simulate abnormal shock. Also, digital signal processing techniques can be used to add various synthetic noises to normal data, such as white noise, natural environmental noise, and signals simulating electromagnetic interference. When introducing these failures and disturbances, the data can be systematically segmented and categorized by time, such as “microphone obstruction-cloth” or “accelerometer shock interference,” to ensure the richness of the dataset and the generalizability of the trained model. These refined operations not only enhance the model's adaptability to complex real-world conditions but also help maintain system performance and stability in a variety of environments.

Step 4: Dataset Balancing. To address the uneven distribution of collected data, data analysis can be performed to identify which categories or scenarios have too few or too many data points. Data augmentation techniques can then be used to increase the number of samples for scarce categories, such as by shifting the speed, adding noise, or using synthetic data generation. For overrepresented categories, downsampling strategies can be used to selectively reduce the number of samples, or cluster analysis can be used to select representative samples. Alternatively, resampling techniques can be used to balance the entire dataset, ensuring that data for each category is evenly distributed within the training set, thereby improving the model's generalization and performance under all conditions. This step can also include applying statistical methods to evaluate changes before and after data balancing to verify the effectiveness of the balancing strategy and adjusting balancing parameters as needed.

Step 5: Set up the model architecture. For example, it is possible to set up the model architecture described in the previous implementation.

Step 6: Model Training. Model training can use customized loss functions to address different classification tasks. For multi-class classification tasks (such as road conditions and weather conditions), cross-entropy loss can be used to ensure the model can effectively distinguish between different classes. For binary classification of sensor states, binary cross-entropy loss can be used to improve sensitivity in distinguishing normal from abnormal states. During training, it is possible to choose the Adam optimizer (Adaptive Moment Estimation), whose adaptive learning rate mechanism helps better handle gradient sparsity, and can also consider using Stochastic Gradient Descent (SGD) with momentum to stabilize the training process. In addition, it is also possible to use early stopping and regularization techniques to prevent overfitting and ensure that the model performs well even on unseen data.

Step 7: Validation and Testing. To ensure the model's effectiveness and reliability in real-world applications, the dataset can be divided into a training set, a validation set, and an independent test set. During model development, the validation set is used for periodic evaluation to monitor training progress and adjust hyperparameters. The test set is used for final evaluation after model training to test the model's performance on completely unseen data. Classification tasks are evaluated using various performance metrics, such as accuracy, precision, recall, and F1 score. The Receiver Operating Characteristic (ROC) curve and Area Under Curve (AUC) values are used to measure the model's performance in detecting sensor state anomalies.

Based on the above embodiments described above, another embodiment of the method for processing vehicle road noise of the present application is proposed. In this embodiment, the same or similar content as the above embodiments can be referred to above and will not be further described. In this embodiment, a load balancing strategy is proposed to enable the algorithm for processing vehicle road noise proposed in the above embodiments to be applied to vehicle RNC systems with limited computing power. For example, a MIMO vehicle-mounted RNC system experiences significant peak computing demands within a single sampling cycle. If a sub-band adaptive algorithm with no output delay is run in real time on an embedded platform such as a Digital Signal Processor (DSP), insufficient peak computing power may prevent the system from running in real time. The load balancing strategy proposed in this embodiment aims to ensure that the sub-band adaptive algorithm with no output delay can run in real time on embedded platforms such as DSPs, resolving the issue of insufficient peak computing power and providing important guarantees for practical applications. Specifically, in this embodiment, the method for processing vehicle road noise further includes step S70:
during N interrupts in (l+1)th frame, performing a task allocated to the N interrupts, where N represents a frame length, and interrupt refers to a period between generating an anti-noise signal based on the time domain reference signal at each sampling point and receiving the time domain reference signal at a next sampling point; and the task allocated to the N interrupts includes the task for calculating the updated time domain adaptive filter coefficients, and/or the task for predicting the environmental state information and/or the sensor state information through the prediction model.

In this embodiment, the control unit implements road noise control using a zero-output-delay approach. Specifically, the time domain reference signal and the time domain error signal collected by the reference sensor are input into the control unit sample by sample in real time. The control unit then generates a single-sample anti-noise signal based on the input single-sample time domain reference signal using the current time domain adaptive filter coefficients, and then outputs this anti-noise signal in real time, achieving zero-output-delay. The adaptive filter coefficients are updated on a frame-by-frame basis. Specifically, the control unit stores the input time domain reference signal and the time domain error signal into corresponding buffers in real time. After each frame of the time domain reference signal and the time domain error signal is fully stored, the control unit performs sub-band decomposition on that frame of the time domain reference signal and the time domain error signal, and subsequently updates the time domain adaptive filter coefficients.

Then, after updating the time domain adaptive filter coefficients based on the time domain reference signal and the time domain error signal of the lth frame, the updated time domain adaptive filter coefficients are used to perform point-by-point processing on the time domain reference signal at the N sampling points of the (l+1)th frame to generate anti-noise signals at the N sampling points. Specifically, each time the time domain reference signal at the sampling point is received, the anti-noise signal at that sampling point is generated and output according to the updated time domain adaptive filter coefficients. It can be understood that, during the point-by-point processing of the time domain reference signal at the N sampling points of the (l+1)th frame, the time domain adaptive filter coefficients must also be updated based on the time domain reference signal and the time domain error signal of the (l+1)th frame to be used for processing the time domain reference signal at each sampling point of the (l+2)th frame to generate anti-noise signals, and so on.

It can be understood that between the time period from receiving the first sample point of the (l+1)th frame to processing the Nth sample point of the (l+1)th frame to generate the anti-noise signal, a single update operation of the time domain adaptive filter coefficients based on the time domain reference signal and the time domain error signal of the lth frame must be completed. In this embodiment, the adaptive filter coefficient update task can be distributed across N interrupts, avoiding the need to execute the entire adaptive filter coefficient update task in a single interrupt, which prevents the problem of insufficient computing power due to a sudden increase in computing power.

Before updating the time domain adaptive filter coefficients based on the time domain reference signal and the time domain error signal of the first frame, the time domain reference signal and the time domain error signal of the first frame, as well as the corresponding sub-band reference signal and sub-band error signal, can be input into a prediction model to predict environmental state information and/or sensor state information. This can then determine the update step size required for updating the filter coefficients based on the environmental state information and/or the sensor state information. Thus, between the start of receiving the first sample point of the (l+1)th frame and the processing of the nth sample point of the (l+1)h frame to generate the anti-noise signal, the task of inputting the time domain reference signal and the time domain error signal of the first frame, as well as the corresponding sub-band reference signal and sub-band error signal, into the prediction model to predict environmental state information and/or sensor state information still needs to be completed. In this embodiment, the prediction task can be distributed across N interrupts to avoid executing the entire prediction task in a single interrupt, thereby avoiding the problem of insufficient computing power due to a sudden increase in computing power.

The load balancing strategy proposed in this embodiment ensures full utilization of each interrupt, avoids overloading any single interrupt, optimizes computing resource usage, and ensures efficient performance and responsiveness in real-time processing. This method of distributing computing tasks across multiple interrupts helps the system maintain stable operation even in the face of high computing demands, thereby achieving continuous and efficient operation in various driving environments.

In this embodiment, there is no restriction on the way of allocating tasks to various interrupts. For example, the computing operations in the task can be divided into multiple subtasks according to the amount of calculation, and the amount of calculation of each subtask is the same or approximately the same, and each interrupt processes one subtask.

In one feasible embodiment, the adaptive filter coefficient update task can be divided into a sub-band decomposition task, a sub-band synthesis task, and multiple sub-band update tasks. Each sub-band update task includes updating at least one sub-band adaptive filter coefficient. The sub-band decomposition task is executed in a first predetermined number of interrupts, the sub-band synthesis task is executed in a second predetermined number of interrupts, and one sub-band update task is executed in each of a third predetermined number of interrupts. The sum of the first predetermined number, the second predetermined number, and the third predetermined number is N.

In one possible implementation, the prediction task can be divided into multiple subtasks, each of which includes processing tasks for at least one layer of the prediction model, and each subtask is executed in each interrupt. For example, if N=64, the first 32 interrupts handle encoder layer operations, including convolution, activation, pooling, and FGRU layers. The second half of the interrupts complete the TGRU and decoder layer operations, and the last interrupt completes the multi-task output layer operations.

It should be noted that when both the adaptive filter coefficient update task and the prediction task need to be allocated to N interrupts, since the prediction task requires sub-band signals, the sub-band decomposition task can be assigned to an earlier interrupt, and the prediction task can be assigned to a later interrupt. For example, each subtask of the prediction task can be assigned to each interrupt other than the first number of interrupts previously preset.

Based on the above embodiments described above, another embodiment of the method for processing vehicle road noise of the present application is provided. In this embodiment, for the same or similar contents as the above embodiments described above, reference can be made to the above description and will not be repeated hereafter. In this embodiment, a polyphase analysis filter bank can be used for sub-band decomposition, and a polyphase synthesis filter bank can be used for sub-band synthesis. Through this sub-band decomposition and sub-band synthesis method, the synthesis filter bank is directly used in the process of restoring the filter coefficients to the full frequency band. It is only necessary to add a synthesis window to the sub-band domain filter and then perform an IFFT (Inverse Fast Fourier Transform) operation to obtain time domain filter coefficients that are almost consistent with the full frequency band, which not only ensures performance but also avoids additional calculations. In specific implementations, an FFT-based polyphase analysis filter bank (hereinafter referred to as a polyphase FFT analysis filter bank) and an IFFT-based polyphase synthesis filter bank (hereinafter referred to as a polyphase IFFT synthesis filter bank) can be employed to further improve computational efficiency. Hereinafter, the analysis filter bank may be referred to as the analysis window, and the synthesis filter bank as the synthesis window.

In one feasible embodiment, the control unit can dynamically determine the filter bank used for sub-band decomposition and sub-band synthesis based on the acquired environmental state information. The determined filter bank is hereinafter referred to as the target filter bank for distinction. The environmental state information can be environmental state information used to dynamically determine the update step size of the sub-band adaptive filter coefficients. The target filter bank can be determined using the latest acquired environmental state information. The target filter bank includes a target polyphase analysis filter bank for sub-band decomposition and a target polyphase synthesis filter bank for sub-band synthesis. A target polyphase analysis filter bank is used to perform sub-band decomposition on the time domain reference signal and the time domain error signal, and a target polyphase synthesis filter bank is used to perform sub-band synthesis of the updated sub-band adaptive filter coefficients. Changes in the external or internal environmental conditions of the vehicle can lead to dynamic changes in the acoustic propagation path, impacting the stability of the road noise. Using a fixed polyphase analysis filter bank and polyphase synthesis filter bank for sub-band decomposition and synthesis may result in an inability to adapt to changing road noise, leading to unstable noise reduction. Therefore, in this embodiment, the target polyphase analysis filter bank and target polyphase synthesis filter bank used for sub-band decomposition and synthesis are dynamically determined based on environmental state information, adapting to environmental changes and improving the stability of the noise reduction effect.

In a specific embodiment, different filter banks can be predetermined for different environmental conditions. Each filter bank includes a polyphase analysis filter bank and a polyphase synthesis filter bank. Then, when the control unit needs to perform sub-band decomposition on the current time domain reference signal and the time domain error signal, and sub-band synthesis on the current sub-band adaptive filter coefficients, it can determine the predetermined filter bank corresponding to the environmental condition represented by the acquired environmental condition information as the target filter bank. The filter banks set for different environmental conditions can be those that have been pre-determined through experiments, statistical analysis, or other methods to provide the best or relatively good noise reduction performance in that environmental condition.

For example, in one feasible embodiment, filter banks pre-configured for different environmental conditions may result in different filter update delays and/or spectral leakage. The filter update delays and spectral leakage resulting from a filter bank are those that would be generated when performing sub-band decomposition and sub-band synthesis using the filter bank. It should be noted that, generally speaking, the filter update delay and spectral leakage introduced by a filter bank are negatively correlated. The greater the delay, the less spectral leakage, and the smaller the delay, the greater the spectral leakage. Lower delays improve system robustness and transient response, while lower spectral leakage improves filtering accuracy and steady-state performance. The stability of road noise varies in different environmental conditions, placing varying demands on system robustness, transient response, filtering accuracy, and steady-state performance. Therefore, dynamically determining the filter bank to be used based on the environmental state information can balance the delay size and spectrum leakage size, and adopt delay and spectrum leakage suitable for the environmental state, thereby balancing the system's robustness, transient response capability, filtering accuracy and steady-state performance, and ensuring the stability of the noise reduction effect.

In one feasible implementation, when the control unit dynamically determines the target filter bank based on the environmental state information, the following rule must be complied with: under the environmental state represented by the environmental state information, the higher the stability of the vehicle road noise, the greater the filter update delay and the smaller the spectrum leakage brought about by the target filter bank; the lower the stability of the vehicle road noise, the smaller the filter update delay and the greater the spectrum leakage brought about by the target filter bank.

It should be noted that if the road noise under the environmental conditions represented by the environmental state information is relatively stable, a filter bank with a longer filter update delay and lower spectral leakage can be used, focusing on improving filtering accuracy and steady-state performance to achieve better noise reduction results. If the road noise under the environmental conditions represented by the environmental state information is relatively stable, a filter bank with a shorter filter update delay and higher spectral leakage can be used, focusing on improving system robustness and transient response, allowing for rapid adaptation to environmental changes and maintaining system stability.

In a specific embodiment, in order to make the control unit comply with the above rule when dynamically determining the target filter bank according to the environmental state information, the filter bank corresponding to each environmental state can be set according to the rule.

In one feasible embodiment, the environmental state information includes weather condition information and road condition information. The weather condition information may specifically be information indicating weather conditions that affect the road surface, such as road dryness, rainfall, and humidity. The road condition information may specifically be information indicating the type of road surface, such as asphalt, potholes, or bricks.

In one feasible implementation, when environmental state information indicates a favorable and stable environment (e.g., good road conditions, clear weather), the vehicle road noise is relatively stable. A filter bank with a longer filter update delay and lower spectral leakage can be used, focusing on improving filtering accuracy and steady-state performance to achieve superior noise reduction. When environmental state information indicates an unstable environment (e.g., deteriorating road conditions, inclement weather), the vehicle road noise may become less stable. In this case, a filter bank with a shorter filter update delay and higher spectral leakage can be used, focusing on improving system robustness and transient response, allowing for rapid adaptation to environmental changes and maintaining system stability.

Table 2 below provides some examples of determining a filter bank based on weather and road condition information. Table 2 provides only some examples and does not limit the method for determining a target filter bank in this embodiment. The information in brackets in the table provides explanations of the weather and road condition information.

TABLE 2
Analysis window and synthesis window selection examples

| | Weather Condition | Analysis and Synthesis Window |
|---|---|---|
| Road Condition Examples | Examples | Examples |
| Smooth asphalt road, | Wet and slippery | Medium leakage, medium delay |
| confidence >90% | accumulation (rainy day | (Environment is stable with slight |
| | or water accumulation | fluctuations, between stable and |
| | section, rainfall about | unstable states. Using analysis and |
| | 5 mm/h), confidence | synthesis windows with medium |
| | >90% | leakage and delay to balance |
| | | response speed and accuracy) |
| Smooth asphalt road, | Dry and sunny | Small leakage, large delay |
| confidence >85% | (temperature 25 °C, | (Relatively stable environment. |
| | humidity 20%), | Using analysis and synthesis |
| | confidence >80% | windows with small leakage and |
| | | large delay to ensure long-term |
| | | stable filtering) |
| Potholed road (uneven), | Dry or slightly wet, | Large leakage, small delay |
| confidence >80% | confidence >80% | (Environment is obviously unstable. |
| | | Using analysis and synthesis |
| | | windows with larger leakage and |
| | | smaller delay to quickly adapt to |
| | | sudden changes) |
| Brick road, confidence >90% | Dry, confidence >80% | Small leakage, large delay (High- |
| | | precision filtering) |
| Ordinary asphalt road | Slightly wet, confidence | Small leakage, large delay |
| (medium smoothness), | >70% | (Conditions are relatively stable. |
| confidence >85% | | Using analysis and synthesis |
| | | windows with small leakage and |
| | | large delay to ensure long-term |
| | | stability) |
| Cement road (hard ground), | Dry, confidence >65% | Small leakage, large delay |
| confidence >80% | | (Environment is basically stable. |
| | | Using analysis and synthesis |
| | | windows with small leakage and |
| | | large delay) |
| Unknown/composite road | Water accumulation, | Medium leakage, medium delay |
| (uncertain structure, other | confidence >65% | (High environmental uncertainty. |
| categories), confidence >60% | | Using analysis and synthesis |
| | | windows with medium leakage and |
| | | delay to balance between fast |
| | | adaptation and precision) |
| Extreme interference | Uncertain, all category | Larger leakage, smaller delay |
| conditions (all error | confidences <55% | (Environment is extremely unstable. |
| differences severely | | Consider using larger leakage and |
| abnormal), all category | | smaller delay to accelerate |
| confidences <60% | | convergence attempts) |

In one feasible implementation, the preset filter banks corresponding to different environmental conditions may be pre-trained with the goal of reducing the filter bank's signal reconstruction loss and spectral leakage loss. It should be noted that the method of training a filter bank to reduce its signal reconstruction loss and spectral leakage loss is similar to the method of training a neural network model to reduce its prediction loss. The steps include preparing training data, designing a loss function, and selecting an optimizer for training. For details, please refer to the neural network model training method. The signal reconstruction loss refers to the error between the signal obtained by performing sub-band decomposition and sub-band synthesis on the signal using the filter bank and the original signal. The spectral leakage loss refers to the amount of spectral leakage generated by the sub-band decomposition of the signal using the filter bank.

In order to train filter banks with different spectral leakage sizes and different filter update delays, different weight combinations of signal reconstruction loss and frequency leakage loss can be set during training. For example, by setting a larger signal reconstruction loss weight and a smaller frequency leakage loss weight, a filter bank with smaller delay and larger leakage can be trained. By setting a smaller signal reconstruction loss weight and a larger frequency leakage loss weight, a filter bank with larger delay and smaller leakage can be trained.

In one feasible embodiment, the signal reconstruction loss is calculated based on the error between a reconstructed signal and a predetermined first-type signal. The reconstructed signal is obtained by performing sub-band decomposition and sub-band synthesis on the predetermined first-type signal using a to-be-trained polyphase analysis filter bank and a to-be-trained polyphase synthesis filter bank. The polyphase analysis filter bank and the polyphase synthesis filter bank can be initialized in advance, and the training process requires updating the coefficients of these polyphase analysis filter bank and polyphase synthesis filter bank. The predetermined first-type signal is a predetermined signal used to calculate the signal reconstruction loss and can be a pre-collected noise signal, vibration signal, music signal, or other type of signal. The predetermined first-type signal is subjected to sub-band decomposition using the to-be-trained polyphase analysis filter bank. The decomposition result is then subjected to sub-band synthesis using the to-be-trained polyphase synthesis filter bank to obtain a reconstructed signal. The error between the reconstructed signal and the predetermined first-type signal is calculated to determine the signal reconstruction loss.

In one feasible embodiment, the spectral leakage loss is calculated based on a target sub-band signal. The target sub-band signal is obtained by performing sub-band decomposition of a predetermined second-type signal using the polyphase analysis filter bank to be trained. The predetermined second-type signal is a single-frequency signal or a narrowband signal within a predetermined frequency band, and the frequency band of the target sub-band signal is a range other than the predetermined frequency band. The predetermined second-type signal is a predetermined signal used for calculating the spectral leakage loss and can be a pre-collected single-frequency signal or a narrowband signal within the predetermined frequency band. The predetermined frequency band can be set as needed. The predetermined second-type signal is decomposed into sub-bands using the polyphase analysis filter bank to be trained. Spectral leakage loss is calculated based on the target sub-band signal in the decomposition results. It can be understood that since the predetermined second-type signal is a single-frequency or narrowband signal within the predetermined frequency band, therefore, after performing the sub-band decomposition on the predetermined second-type signal, if there is no spectral leakage, the sub-band decomposition results will contain no signal outside the predetermined frequency band. Since the frequency band of the target sub-band signal is outside the predetermined frequency band, the magnitude of the target sub-band signal can represent the magnitude of spectral leakage, and spectral leakage loss can be calculated based on the target sub-band signal.

In one feasible implementation, the filter bank can be trained as follows:

Step 1: Data Preparation. Two types of data are used to train the analysis filter bank and the synthesis filter bank. The first type consists of various noise, vibration, and music signals. The second type consists of uniformly generated single-frequency or narrowband signals within a known frequency band (hereinafter, “S” represents the set of sub-band indices within this frequency band). These two types of data each account for 50% of the total data.

Step 2: Design the loss function. Signal reconstruction error and spectrum leakage energy are two metrics for measuring the performance of the sub-band analysis and synthesis windows. Therefore, these two metrics are used as the loss function for training.

$${L}_{total} = α {L}_{MSE} + β {L}_{Leakage}$$

$${L}_{MSE} = \frac{1}{R} {\sum }_{r = 0}^{R - 1} {( z [ r ] - {z}^{′} [ r ] )}^{2}$$

$${L}_{leakage} = {\sum }_{k ∉ S} Z {\vert [ k ] \vert}^{2}$$

L_{MSE} is signal reconstruction loss function, L_{leakage} is the signal spectral leakage loss function, α and β are weighting coefficients for adjusting the impact ratio of the two losses, for example, set to α=0.4 and β=0.6. z[r] is the preset first-type signal, z′[r] is the signal after z[r] is decomposed and synthesized, i.e., the reconstructed signal. R is the signal length, for example, set to R=20000. Z[k] is the sub-band signal after the preset second-type signal is decomposed, k is the sub-band index, and S is the set of sub-band indices within the known frequency range from step 1.

Step 3: Select an optimizer for training. Calculate L_{MSE} based on the input of the preset first-type signal, and calculate L_{leakage} based on the input of the preset second-type signal. Combine these two losses to form the final loss Lₜₒₜₐₗ. Pytorch (an open-source deep learning framework for machine learning and deep learning) can be used as the training environment, and Adam can be selected as the optimizer. Iterate the training of the analysis and synthesis windows until the loss function converges, ultimately obtaining the trained analysis and synthesis windows. The downsampling factor can be set to 3, and the number of FFT points P can be set to 128, resulting in a 128*3 analysis and synthesis window size. During training, a 128*3 Hamming window can be used as the initial coefficient.

Based on the above embodiments described above, another embodiment of the method for processing vehicle road noise of the present application is provided. In this embodiment, the same or similar contents as those of the above embodiments can be referred to above and will not be further elaborated. In this embodiment, a target amplitude limitation parameter value can also be dynamically determined based on acquired environmental state information and/or sensor state information. After generating an anti-noise signal, the target amplitude limitation parameter value is used to limit the amplitude of the anti-noise signal, and the amplitude-limited anti-noise signal is output to control road noise. That is, a post-processing operation can be performed on the anti-noise signal. This post-processing operation includes amplitude limitation the anti-noise signal, and the amplitude limitation is performed according to a target amplitude limitation parameter value determined based on environmental state information and/or sensor state information. The amplitude limitation parameter value is used to limit the degree of amplitude limitation. The specific parameter is not limited in this embodiment. For example, it can be an upper amplitude limit value, indicating that the amplitude of the final output signal is not allowed to exceed this upper amplitude limit value.

It should be noted that changes in the environmental conditions outside or inside the vehicle can cause dynamic changes in the acoustic propagation path, impacting the stability of road noise. If a fixed amplitude limitation parameter value is used to limit the amplitude of the anti-noise signal, when the stability of the road noise changes, the amplitude limitation may be too large to fully offset the noise. It is also possible that the amplitude limitation is too small to cause noise or distortion due to misjudgment or overcompensation. Therefore, in specific embodiments, the amplitude limitation parameter value can be dynamically adjusted based on environmental information to dynamically control the output amplitude of the anti-noise signal, adapting to different environmental conditions, which ensures good noise reduction while preventing the introduction of noise or distortion due to misjudgment or overcompensation, thus ensuring system stability and security.

Changes in the operating state of the reference sensor or the error sensor can affect the accuracy of the acquired signal. For example, if the reference sensor or the error sensor experiences an anomaly, the acquired signal accuracy decreases, leading to an erroneous estimation of the road noise in the signal. The generated anti-noise signal may not only fail to offset the noise but may actually introduce noise. Therefore, in specific embodiments, the amplitude limitation parameter value can be dynamically adjusted based on sensor state information to dynamically control the output amplitude of the anti-noise signal. For example, when a sensor anomaly occurs, the output amplitude can be reduced to avoid the introduction of noise or distortion due to misjudgment or overcompensation.

The specific method for determining the target amplitude limitation parameter value based on the environmental state information and/or the sensor state information is not limited in this embodiment. For example, a mapping relationship between the environmental state information and/or the sensor state information and the amplitude limitation parameter value can be pre-set as needed. After obtaining the environmental state information and/or the sensor state information, the control unit uses the amplitude limitation parameter value corresponding to the environmental state information and/or the sensor state information as the target amplitude limitation parameter value based on the mapping relationship. In this embodiment, there is no limitation on the mapping relationship. For example, the mapping relationship can be expressed in a mapping table, a relational expression, or the like. The mapping relationship can also be determined through experiments, statistical data, or other methods.

In one feasible implementation, the control unit may be configured to comply with one or more of the following rules when determining the target amplitude limitation parameter value according to the influencing factor information:

1. The higher the stability of the vehicle road noise under the environmental state represented by the environmental state information, the smaller the degree of amplitude limitation of the anti-noise signal according to the target amplitude limitation parameter value; the lower the stability of the vehicle road noise under the environmental state represented by the environmental state information, the greater the degree of amplitude limitation of the anti-noise signal according to the target amplitude limitation parameter.

If the stability of vehicle road noise is high under the environmental state represented by the environmental state information, the amplitude limitation parameter value with a smaller amplitude limitation of the anti-noise signal can be used, that is, an anti-noise signal with a larger amplitude is allowed to be output, thereby more fully offsetting the noise and ensuring a good noise reduction effect. If the stability of vehicle road noise under the environmental state represented by the environmental state information is low, the amplitude limitation parameter value with a greater degree of amplitude limitation for the anti-noise signal can be used, that is, the amplitude of the output signal is limited to a greater extent to avoid the introduction of noise or distortion due to system misjudgment or overcompensation, thereby ensuring system stability.

2. The higher the degree of abnormality of the sensor represented by the sensor state information, the greater the degree of amplitude limitation of the anti-noise signal according to the target amplitude limitation parameter; the lower the degree of abnormality of the sensor represented by the sensor state information, the smaller the degree of amplitude limitation of the anti-noise signal according to the target amplitude limitation parameter.

The higher the degree of abnormality of the sensor, the greater the amplitude limitation applied to the noise signal, thereby preventing the introduction of noise or distortion due to misjudgment or overcompensation.

In one feasible embodiment, based on the environmental state information and/or the sensor state information, a target amplitude limitation parameter value can also be determined based on vehicle speed. When determining the target amplitude limitation parameter value based on vehicle speed, the following rules apply:

3. When the vehicle speed stability is higher, the degree of amplitude limitation of the anti-noise signal according to the target amplitude limitation parameter is smaller; when the vehicle speed stability is lower, the degree of amplitude limitation of the anti-noise signal according to the target amplitude limitation parameter is larger.

Vehicle speed stability, for example, refers to the rate of change of vehicle speed. A greater rate of change indicates lower speed stability, while a smaller rate of change indicates higher speed stability.

When vehicle speed stability is high, the stability of vehicle road noise is higher. In this case, the amplitude limitation parameter value with a smaller amplitude limit for the anti-noise signal can be used. This allows the output of an anti-noise signal with a larger amplitude, thereby more effectively offsetting noise and ensuring a good noise reduction effect. When vehicle speed stability is low, the stability of vehicle road noise is lower. In this case, the amplitude limitation parameter value with a larger amplitude limit for the anti-noise signal can be used. This limits the amplitude of the output signal to a greater extent, avoiding the introduction of noise or distortion due to system misjudgment or overcompensation, thereby ensuring system stability.

In a specific embodiment, to ensure that the control unit complies with one or more of the above-mentioned rules when determining the target amplitude limitation parameter value, a mapping relationship that satisfies one or more of the above-mentioned rules may be set. Based on the mapping relationship, the control unit determines the amplitude limitation parameter value corresponding to the environmental state information, the sensor state information, and the vehicle speed as the target amplitude limitation parameter value. The mapping relationship may be represented by a mapping table, a relational expression, or the like. It should be noted that when multiple rules are required to be met, the multiple rules may be prioritized to avoid conflicts. The specific priority order can be set as needed and is not limited here. For example, determining the amplitude limitation parameter value based on the sensor state information may have a higher priority than determining the amplitude limitation parameter value based on the environmental state information.

In one feasible embodiment, when the environmental state information and the sensor state information indicate that the environment is good and stable (for example, good road conditions, clear weather, normal sensor operation, and moderate vehicle speed), the vehicle road noise is relatively stable. In this case, the amplitude limitation parameter value with a smaller amplitude limitation of the anti-noise signal can be used, allowing the output of an anti-noise signal with a larger amplitude, thereby more fully offsetting the noise and ensuring a good noise reduction effect. When the environmental state information and the sensor state information indicate deteriorating or unstable conditions (for example, deteriorating road conditions, severe weather, sensor anomalies, or drastic speed fluctuations), the stability of vehicle road noise may deteriorate. In this case, a more aggressive amplitude limitation parameter can be used to combat the noise signal. This significantly limits the output signal amplitude, preventing noise or distortion introduced by system misjudgment or overcompensation and ensuring system stability. When the environmental state information and the sensor state information indicate extremely harsh conditions or system anomalies (for example, extremely harsh road conditions, severe sensor failure, or extremely low speeds), the output signal amplitude can be significantly limited to prioritize system safety.

Table 3 below provides some examples of determining output limiters based on weather information, road conditions, sensor state information, and vibration sensor signal characteristics (acceleration amplitude, energy, and sound pressure signal amplitude). Table 3 provides only some examples and does not limit the method for determining target amplitude limitation parameters in this embodiment. The information in parentheses in the table explains the weather information, road conditions, sensor state information, and output amplitude limitation.

TABLE 3
Output amplitude limitation selection example

| Road Condition | Weather Condition | | Output Limiting |
|---|---|---|---|
| Examples | Examples | Sensor State Examples | Examples |
| Smooth asphalt road, | Wet and slippery | All sensors working | Maximum output |
| confidence >90% | (rainy day or water | normally, | gain limit: +6 dB |
| | accumulation | confidence >90%, vibration | (relative to |
| | section, rainfall | sensor acceleration | baseline) |
| | about 5mm/h), | amplitude <0.02 g, energy | (Prevent low- |
| | confidence >90% | <0.01 g² · s, sound pressure | frequency boom |
| | | signal amplitude <65 dB(A) | when over- |
| | | (mainly low-frequency | outputting, but |
| | | components) | ensure |
| | | | suppression |
| | | | effect) |
| Smooth asphalt road, | Dry and sunny | Error microphone abnormal | Maximum output |
| confidence >85% | (temperature 25 °C, | operation (e.g., slight | gain limit: +4 dB |
| | humidity 20%), | blockage), | (relative to |
| | confidence >80% | confidence >90%, vibration | baseline) (Avoid |
| | | sensor acceleration | excessive |
| | | amplitude <0.04 g, energy | amplification due |
| | | <0.015 g² · s, sound pressure | to uncertainty of |
| | | signal amplitude <65 dB(A) | slightly blocked |
| | | (overall stable) | signals) |
| Potholed road | Dry or slightly wet, | Vibration sensor abnormal | Maximum output |
| (uneven), | confidence >80% | operation (overshoot or | gain limit: +2 dB |
| confidence >80% | | distortion), | (relative to |
| | | confidence >60%, vibration | baseline), and |
| | | sensor acceleration | limit high- |
| | | amplitude <1 g (with short- | frequency output |
| | | term impacts), energy | peak ≤55 dB(A) |
| | | <0.04 g² · s, sound pressure | |
| | | signal amplitude <65 dB(A) | |
| Brick road, | Dry, | Sensors working normally, | Maximum output |
| confidence >90% | confidence >80% | confidence >80%, vibration | gain limit: +6 dB |
| | | sensor acceleration | (relative to |
| | | amplitude <0.02 g, energy | baseline) (Ensure |
| | | <0.015 g² · s, sound pressure | mid-frequency |
| | | signal amplitude <65 dB(A), | noise is fully |
| | | mainly mid-frequency | canceled) |
| | | characteristics | |
| Ordinary asphalt road | Slightly wet, | Sensors working normally, | Maximum output |
| (medium smoothness), | confidence >70% | confidence >80%, vibration | gain limit: +4 dB |
| confidence >85% | | sensor acceleration | (relative to |
| | | amplitude <0.03 g, energy | baseline) |
| | | <0.02 g² · s, sound pressure | (Maintain |
| | | signal amplitude <45 dB(A) | general noise |
| | | (mostly mid-to-low | reduction |
| | | frequency components) | without extreme |
| | | | limitations) |
| Cement road (hard | Dry, | Error microphone abnormal | Maximum output |
| ground), | confidence >65% | operation (wind noise | gain limit: +3 dB |
| confidence >80% | | interference), | (relative to |
| | | confidence >70%, vibration | baseline) (Limit |
| | | sensor amplitude <0.04 g, | over- |
| | | medium energy, sound | compensation in |
| | | pressure signal amplitude | case of wind |
| | | <50 dB(A) | noise |
| | | | interference) |
| Unknown/composite | Water | Error microphone abnormal | Maximum output |
| road (uncertain | accumulation, | operation (possible partial | gain limit: +2 dB |
| structure, other | confidence >65% | blockage), vibration sensor | (relative to |
| categories), | | signal fluctuates greatly, | baseline) (And |
| confidence >60% | | amplitude <1 g but unstable, | flexibly contract |
| | | sound pressure signal | or relax |
| | | amplitude <55 dB(A) | according to |
| | | (frequency distribution | short-term |
| | | uncertain) | monitoring |
| | | | mechanism) |
| Extreme interference | Uncertain, all | Error | Maximum output |
| conditions (all error | category | microphones/vibration | gain limit: −2 dB |
| mics severely | confidences <55% | sensors all abnormal | (below baseline) |
| abnormal), all category | | operation (distortion, highly | (Enter ‘safe |
| confidences <60% | | likely blockage or excessive | mode’, limit |
| | | noise), vibration sensor | output below |
| | | amplitude >2 g, | 50 dB(A)) |
| | | energy >0.1 g² · s, sound | |
| | | pressure signal | |
| | | amplitude >70 dB(A) | |

Based on the above embodiments, another embodiment of the method for processing vehicle road noise of the present application is provided. In this embodiment, for the same or similar contents as those in the above embodiments, reference may be made to the above description and will not be further elaborated. In this embodiment, pre-weighting weights corresponding to each sensor may be determined based on acquired environmental state information and/or sensor state information. The reference signal and the error signal are weighted using the pre-weighting weights corresponding to each sensor before being used to generate an anti-noise signal and update the coefficients of the adaptive filter. That is, the input reference signal and error signal are pre-processed. The pre-processing operation includes amplitude adjustment, and the amplitude adjustment is performed according to the pre-weighting weights corresponding to each sensor determined based on the environmental state information and/or the sensor state information.

It should be noted that changes in the environmental conditions outside or inside the vehicle cause dynamic shifts in the acoustic propagation path, affecting the energy level of road noise. The impact on road noise energy in different frequency bands may also vary. If a fixed amplitude adjustment strategy is used for the reference signal and the error signal, when the energy level of road noise changes, the weak noise signal in the reference signal and the error signal may prevent the generation of a more targeted anti-noise signal, resulting in poor noise reduction effectiveness. Therefore, in a specific embodiment, the pre-weighting weights of each sensor can be dynamically adjusted based on environmental state information. Since the signals collected by different sensors may be distributed in different frequency bands, by adjusting the pre-weighting weights of the sensors, the signals in each frequency band can be targetedly enhanced or weakened. For example, a higher pre-weighting weight can be set for the sensor corresponding to the sub-band with stronger vehicle road noise energy, thereby enabling the generation of more targeted anti-noise signals and improving the noise reduction effect.

Changes in the operating state of the reference sensor or the error sensor can affect the accuracy of the collected signal. For example, if the reference sensor or the error sensor experiences an anomaly, the accuracy of the collected signal decreases, leading to an erroneous estimation of the road noise in the signal. The generated anti-noise signal may not only fail to offset the noise but may actually introduce noise. Therefore, in specific embodiments, the pre-weighting of each sensor can be dynamically adjusted based on sensor state information, for example, by reducing the pre-weighting of an abnormal sensor. This prevents noise or distortion introduced by misjudgment or overcompensation, thereby ensuring system safety and robustness.

The specific method for determining pre-weighting weights based on environmental state information and/or the sensor state information is not limited in this embodiment. For example, a mapping relationship between the environmental state information and/or the sensor state information and the pre-weighting weights can be pre-set as needed. After obtaining the environmental state information and/or the sensor state information, the control unit uses the pre-weighting weight corresponding to the environmental state information and/or the sensor state information as the target pre-weighting weight based on the mapping relationship. In this embodiment, the mapping relationship is not limited. For example, the mapping relationship can be expressed using a mapping table, a relational expression, or the like, and can be determined through experiments, statistical data, or other methods.

In one feasible implementation, the control unit may be configured to determine the pre-weighting weights based on the environmental state information and/or the sensor state information in accordance with one or more of the following rules:

1. Under the environmental state represented by the environmental state information, the pre-weighting weights of sensors corresponding to sub-bands with higher road noise energy are greater than the pre-weighting weights of sensors corresponding to sub-bands with lower road noise energy.

A sensor corresponding to a sub-band refers to a sensor whose signal is distributed entirely or primarily in that sub-band.

Under the same environmental conditions, the distribution of vehicle road noise across sub-bands may be different. For sensors corresponding to sub-bands with higher noise energy, a larger pre-weighting weight can be used to specifically enhance the noise reduction strength of that sub-band and improve the noise reduction effect. For sub-bands with lower noise energy, a smaller pre-weighting weight can be used to avoid the introduction of noise or distortion due to misjudgment or overcompensation.

2. For any target sub-band, the higher the energy of the vehicle road noise in the target sub-band under the environmental state represented by the environmental state information, the greater the pre-weighting weight of the sensor corresponding to the target sub-band; and the lower the energy of the vehicle road noise in the target sub-band under the environmental state represented by the environmental state information, the smaller the pre-weighting weight of the sensor corresponding to the target sub-band.

For the same sub-band, the energy of road noise may vary under different environmental conditions. Therefore, for a specific sub-band (referred to as the target sub-band for distinction), if the energy of road noise in the target sub-band is higher under certain environmental conditions, a larger pre-weighting weight can be used for the sensor corresponding to the target sub-band, specifically enhancing the noise reduction strength in that sub-band and improving the noise reduction effect. If the energy of road noise in the target sub-band is lower under certain environmental conditions, a smaller pre-weighting weight can be used for the sensor corresponding to the target sub-band to avoid noise or distortion introduced by misjudgment or overcompensation.

3. According to the abnormality degree of each sensor represented by the sensor state information, the pre-weighting weight corresponding to the sensor with a higher abnormality degree is lower, and the pre-weighting weight corresponding to the sensor with a lower abnormality degree is higher.

Based on the acquired sensor state information, the degree of abnormality of each sensor can be determined, and the degree of abnormality of each sensor may be different. For sensors with a higher degree of abnormality, a smaller pre-weighting weight can be used to avoid the introduction of noise or distortion due to misjudgment or over-compensation. For sensors with a lower degree of abnormality, a larger pre-weighting weight can be used to ensure the noise reduction effect of the system.

In a specific embodiment, to ensure that the control unit complies with one or more of the above-mentioned rules when determining the pre-weighting weights for each sensor, a mapping relationship that satisfies one or more of the above-mentioned rules may be set. The control unit determines, based on the mapping relationship, the pre-weighting weight corresponding to the environmental state information and/or the sensor state information as the target pre-weighting weight. The mapping relationship may be represented by a mapping table, a relational expression, or other means. It should be noted that when multiple rules are required to be met, the rules may be prioritized to avoid conflicts. The specific priority order can be set as needed and is not limited here. For example, determining the pre-weighting weight based on the sensor state information may have a higher priority than determining the pre-weighting weight based on the environmental state information.

In one feasible embodiment, the environmental state information includes weather condition information and road condition information. The weather condition information may specifically be information indicating weather conditions that affect the road surface, such as road dryness, rainfall, and humidity. The road condition information may specifically be information indicating the type of road surface, such as asphalt, potholes, or bricks.

In one feasible implementation, the frequency bands can be divided into three: low-frequency, mid-frequency, and high-frequency. When environmental conditions indicate high low-frequency noise energy (e.g., wet and flooded weather), a higher pre-weighting weight can be applied to the signals collected by low-frequency sensors (sensors whose signals are primarily distributed in the low-frequency range). For example, a pre-weighting of +20% can be applied to the signals collected by low-frequency sensors, while the remaining sensor channels maintain a baseline of 1.0. When environmental conditions indicate high mid-frequency noise energy (e.g., brick pavement, dry weather), a higher pre-weighting weight can be applied to the signals collected by mid-frequency sensors (sensors whose signals are primarily distributed in the mid-frequency range). For example, a pre-weighting of +20% can be applied to the signals collected by mid-frequency sensors, while the remaining sensor channels maintain a baseline of 1.0.

Table 4 below provides some examples of determining pre-weighting strategies based on weather information, road conditions, sensor state information, and vibration sensor signal characteristics (acceleration amplitude, energy, and sound pressure signal amplitude). Table 4 is merely an example and does not limit the method for determining pre-weighting weights in this embodiment. The information in parentheses in the table explains the weather information, road conditions, sensor state information, and pre-weighting strategies.

TABLE 4
Pre-weighting strategy selection example

| Road Condition | Weather Condition | | Pre-weighting |
|---|---|---|---|
| Examples | Examples | Sensor State Examples | Strategy Examples |
| Smooth asphalt road, | Wet and slippery | All sensors working | Pre-weight low- |
| confidence >90% | (rainy day or water | normally, | frequency reference |
| | accumulation | confidence >90%, | signals (water |
| | section, rainfall | vibration sensor | accumulation |
| | about 5 mm/h), | acceleration amplitude | noise) by +20%, |
| | confidence >90% | <0.02 g, energy <0.01 g² · s, | keep other |
| | | sound pressure signal | reference channels |
| | | amplitude <65 dB(A) | at 1.0 baseline |
| | | (mainly low-frequency | |
| | | components) | |
| Smooth asphalt road, | Dry and sunny | Error microphone | Reduce pre- |
| confidence >85% | (temperature 25 °C, | abnormal operation (e.g., | weighting of |
| | humidity 20%), | slight blockage), | blocked error |
| | confidence >80% | confidence >90%, | microphone to 0.8. |
| | | vibration sensor | Keep weights of |
| | | acceleration amplitude | other microphones |
| | | <0.04 g, sound energy | and vibration |
| | | <0.015 g² · s, | sensors at 1.0 |
| | | pressure signal amplitude | |
| | | <65 dB(A) (overall stable) | |
| Potholed road | Dry or slightly wet, | Vibration sensor abnormal | If vibration sensor |
| (uneven), | confidence >80% | operation (overshoot or | amplitude >0.8 g, |
| confidence >80% | | distortion), | reduce pre- |
| | | confidence >60%, | weighting to 0.7 |
| | | vibration sensor | (30% reduction), |
| | | acceleration amplitude | enhance proportion |
| | | <1 g (with short-term | of error |
| | | impacts), energy | microphones in |
| | | <0.04 g² · s, sound pressure | mid-high frequency |
| | | signal amplitude | channels |
| | | <65 dB(A) | |
| Brick road, | Dry, | Sensors working normally, | Pre-weight mid- |
| confidence >90% | confidence >80% | confidence >80%, | frequency channels |
| | | vibration sensor | by +25%, maintain |
| | | acceleration amplitude | other frequency |
| | | <0.02 g, energy | bands at 1.0 |
| | | <0.015 g² · s, sound | baseline |
| | | pressure signal amplitude | |
| | | <65 dB(A), mainly mid- | |
| | | frequency characteristics | |
| Ordinary asphalt road | Slightly wet, | Sensors working normally, | Error microphones |
| (medium | confidence >70% | confidence >80%, | and vibration |
| smoothness), | | vibration sensor | sensors pre- |
| confidence >85% | | acceleration amplitude | weighted = 1.0 |
| | | <0.03 g, energy <0.02 g² · s, | (default) |
| | | sound pressure signal | |
| | | amplitude <45 dB(A) | |
| | | (mostly mid-to-low | |
| | | frequency components) | |
| Cement road (hard | Dry, | Error microphone | Reduce pre- |
| ground), | confidence >65% | abnormal operation (wind | weighting of wind |
| confidence >80% | | noise interference), | noise-affected |
| | | confidence >70%, | microphones to 0.7, |
| | | vibration sensor amplitude | keep other signal |
| | | <0.04 g, medium energy, | channels |
| | | sound pressure signal | unchanged |
| | | amplitude <50 dB(A) | |
| Unknown/composite | Water | Error microphone | Reduce pre- |
| road (uncertain | accumulation, | abnormal operation | weighting of |
| structure, other | confidence >65% | (possible partial | blocked |
| categories), | | blockage), vibration | microphone |
| confidence >60% | | sensor signal fluctuates | references to 0.5, |
| | | greatly, amplitude <1 g but | increase weights of |
| | | unstable, sound pressure | other normal |
| | | signal amplitude | microphones, keep |
| | | <55 dB(A) (frequency | vibration sensor at |
| | | distribution uncertain) | 1.0 if normal |
| Extreme interference | Uncertain, all | Error | Reduce pre- |
| conditions (all error | category | microphones/vibration | weighting of all |
| mics severely | confidences <55% | sensors all abnormal | abnormal channels |
| abnormal), all | | operation (distortion, | to 0.2~0.3 |
| category confidences | | highly likely blockage or | |
| <60% | | excessive noise), vibration | |
| | | sensor amplitude >2 g, | |
| | | energy >0.1 g² · s, sound | |
| | | pressure signal | |
| | | amplitude >70 dB(A) | |

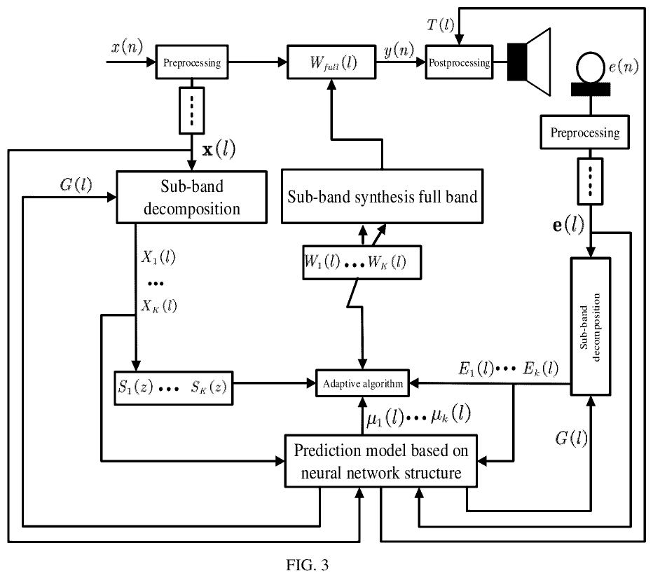

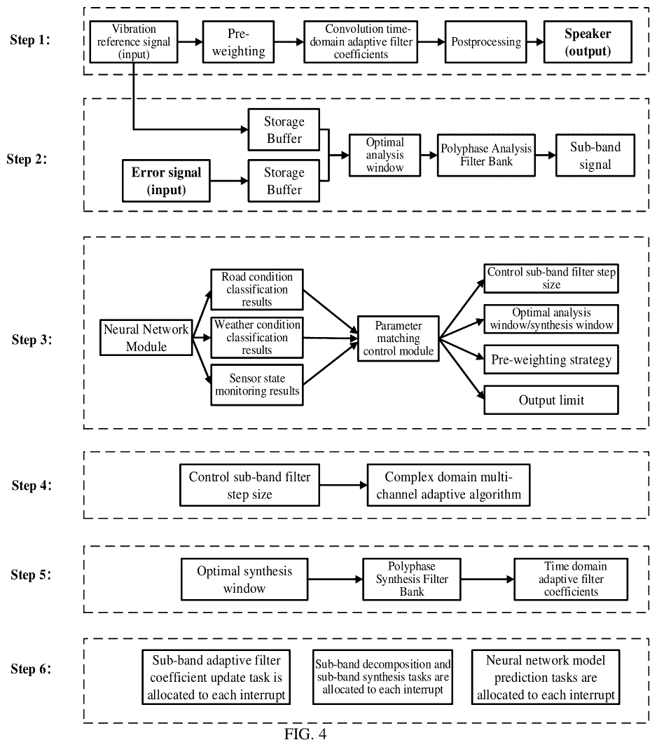

To help understand the implementation process of the above embodiments of the method for processing vehicle road noise, an implementation example is given. FIG. 3 is a diagram of the signal processing process involved in this example of the method for processing vehicle road noise, and FIG. 4 is a schematic flow chart of this example of the method for processing vehicle road noise.

### Step 1

After pre-processing, such as pre-filtering and amplitude adjustment, the J-channel time domain vibration reference signal x(n) is convolved with the time domain adaptive filter coefficients, where 1 represents the frame index, indicating that it is updated on a per-frame basis, rather than at the sampling time n. The resulting convolved signal becomes the Q-channel y(n). After post-processing, such as amplitude limiting, it is output to each of the Q speakers. Signal x(n) can be amplitude-adjusted according to the pre-weighting weights determined in step 3. Signal y(n) can be amplitude-limited according to the target amplitude limitation parameter value T(l) determined in step 3.

### Step 2

The J-channel time domain vibration reference signal x(n) and the M-channel time domain error microphone signal e(n) are placed in two buffers with lengths of J*N and M*N respectively. N is the frame length, in this example J=9, M=2, Q=5, N=64. When the buffer is full, a frame of the J-channel time domain vibration reference signal x(l) and a frame of the M-channel time domain error microphone signal e(l) are obtained. The above signals x(l) and e(l) are decomposed into sub-bands using a polyphase analysis filter bank based on FFT to obtain a frame of the J-channel sub-band vibration reference signal Xₖ(l) and a frame of the M-channel sub-band vibration reference signal Eₖ(l)

$${X}_{k} ( l ) = [ {X}_{k}^{1} ( l ) , {X}_{k}^{2} ( l ) … {X}_{k}^{J} ( l ) ]$$

$${E}_{k} ( l ) = [ {E}_{k}^{1} ( l ) , {E}_{k}^{2} ( l ) … {E}_{k}^{M} ( l ) ]$$

k=1, 2 . . . K, K is the total number of sub-bands, in this example K=65. In addition, the polyphase analysis filter bank trained according to the training method in the above embodiment can be used as the prototype low-pass filter in the sub-band decomposition.

H_{G(l)}(d)=[h₁(d),h₂(d) . . . h_{P}(d)]

H_{G(l)}(d) is the target polyphase analysis filter bank matched according to G(l), and G(l) is the identifier of the analysis filter bank and the synthesis filter bank determined according to the environmental state information. The formula for sub-band decomposition of the time domain vibration reference signal x(l) is as follows:

$${x}^{′} ( l ) = {\sum }_{d = 0}^{D - 1} h ( d ) x ( l - d ) \qquad ( 1 )$$

$${X}_{k} ( l ) = {\sum }_{p = 0}^{P - 1} {x}^{′} ( l ) {e}^{v} \qquad ( 2 )$$

D is the downsampling factor, P is the length of the FFT, in this example D=3, P=128. In formula (2), v=−2πikp/P, and i is the imaginary unit.

Formula (1) describes the polyphase filtering process for the signal x(l). Specifically, a sub-band analysis window is first applied to the signal x(l), and then the windowed results are accumulated to obtain x′(l). Formula (2) performs a Discrete Fourier Transform (DFT) on the signal x′(l) to obtain the sub-band vibration reference signal

$${X}_{k} ( l )$$

In actual calculations, an FFT can be used to increase computation speed. The formula for sub-band decomposition of the time domain error microphone signal e(l) is not repeated here.

### Step 3

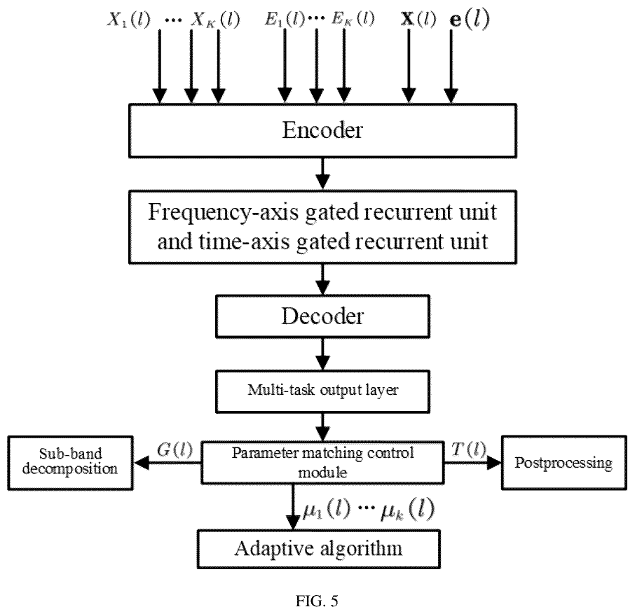

As shown in FIG. 5, a frame of J-channel sub-band vibration reference signal

$${X}_{1} ( l ) … {X}_{K} ( l ) ,$$

a frame of M-channel sub-band error Mike signal

$${E}_{1} ( l ) … {E}_{K} ( l )$$

a frame of J-channel time domain vibration reference signal x(l), and a frame of M-channel time domain error Mike signal e(l) are input into a prediction model based on a neural network structure (U-Net Encoder+FT-GRU+U-Net Decoder+multi-task output layer) to predict road condition information, weather condition information, and sensor state information. The corresponding functions of the parameter matching control module in FIG. 5 are: dynamically determining the update step size of the sub-band adaptive filter coefficients

$${μ}_{1} ( l ) … {μ}_{K} ( l )$$

based on road condition information, weather condition information, and sensor state information; dynamically determining the target filter bank based on road condition information and weather condition information, with G(l) representing the identifiers of the analysis filter bank and synthesis filter bank determined based on the road condition information and weather condition information; determining the pre-weighting weights and target amplitude limitation parameter value T(l) for each sensor based on road condition information, weather condition information, and sensor state information.

### Step 4

Since the sub-bands decomposed by the FFT-based polyphase analysis filter bank are complex domain sub-bands, the complex domain FxLMS algorithm is used to update the sub-band adaptive filter coefficients

$${W}_{k} ( l ) .$$

The size of each

$${W}_{k} ( l )$$

is C*J*Q, C is the length of the sub-band adaptive filter coefficients. In this example, C=4. In the complex domain FxLMS algorithm, the input sub-band vibration reference signal Xₖ(l) is first convolved with the secondary path model S (k). This convolution is a complex convolution.

X′_{mgk}^{j}(l)=S_{mqk}*Xₖ^{j}(l)

Then the complex domain LMS algorithm is used to update the sub-band adaptive filter coefficients Wₖ(l):

$${X}_{qk}^{j} ( l ) = {W}_{qk}^{j} = {μ}_{k} ( l ) * {\sum }_{m = 1}^{M} {E}_{k}^{m} ( l ) {X}_{mqk}^{{′}^{* j}} ( l )$$

q=1, 2 . . . Q, where Q is the number of loudspeaker signal channels. m=1, 2 . . . M, where M is the number of error microphone signal channels. j=1, 2 . . . J, where J is the number of vibration reference signal channels. k=1, 2 . . . K, where K is the number of sub-bands. is the update step size of the sub-band adaptive filter coefficients, determined based on the influencing factor information, and is used to control the filter update speed.

Step 5: Synthesize the sub-band adaptive filter coefficients into the time domain adaptive filter coefficients.

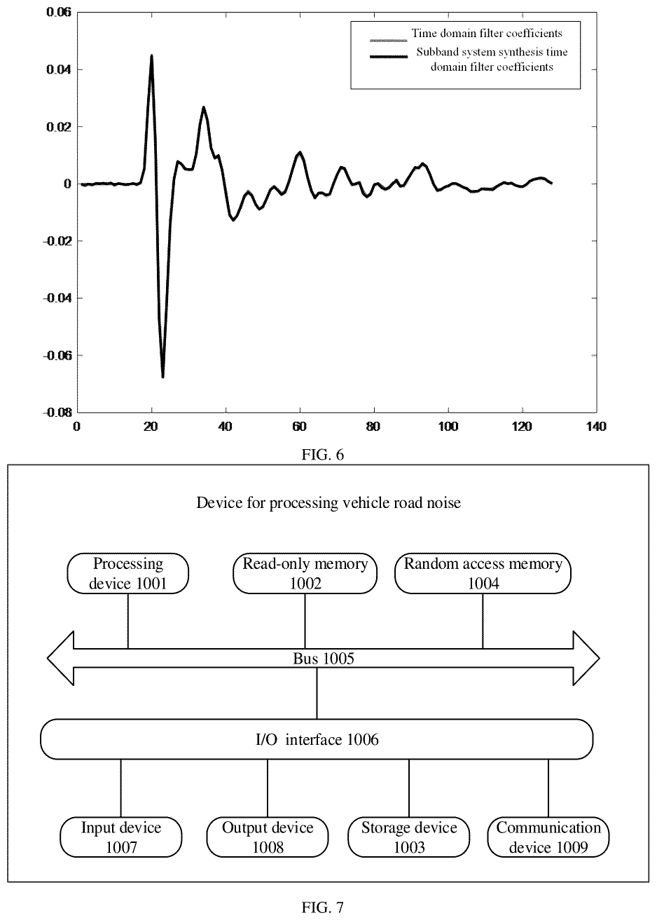

Sub-band synthesis is performed using an IFFT-based polyphase synthesis filter bank. Compared to the computationally intensive weight stacking method, which involves multiple FFT and IFFT operations, this method requires only one IFFT and windowing operation, resulting in a simple and efficient method. The polyphase synthesis filter bank can utilize the polyphase analysis filter bank trained using the training method described in the above embodiment, and can be dynamically determined based on environmental state information. As shown in FIG. 6, in this example, the full-band (time domain) adaptive filter coefficients synthesized from the sub-band adaptive filter coefficients can achieve an effect that is nearly identical to the target full-band (time domain) adaptive filter coefficients. In FIG. 6, the abscissa represents the filter length index, and the ordinate represents the coefficient value corresponding to each tap.

Step 6: Load Balancing Strategy. Distribute the tasks of sub-band decomposition, sub-band synthesis, and updating the sub-band adaptive filter coefficients to each interrupt, and distribute the neural network model prediction task to each interrupt.

It should be noted that the sequence numbers of the above steps do not restrict the order of the steps. Furthermore, the above examples are provided for understanding the present application only and do not constitute a limitation on the method for processing vehicle road noise of the present application. Simple variations based on this technical concept are all within the scope of the present application.

The embodiments of the present application further provide an apparatus for processing vehicle road noise, including a sub-band decomposition module, a step size updating module, a filter updating module, a sub-band synthesis module and an anti-noise module.

The sub-band decomposition module is configured for performing sub-band decomposition on an input time domain reference signal and an input time domain error signal to obtain a sub-band reference signal and a sub-band error signal.

The step size updating module is configured for dynamically determining a target update step size corresponding to sub-band adaptive filter coefficients based on acquired influencing factor information, where the influencing factor information includes environmental state information and/or sensor state information, the environmental state information is information representing an environmental state inside and/or outside a vehicle, the sensor state information is information representing an operating state of a sensor, and the sensor includes the sensor for collecting the time domain reference signal and/or the sensor for collecting the time domain error signal.

The filter updating module is configured for updating the sub-band adaptive filter coefficients according to the target update step size based on the sub-band reference signal and the sub-band error signal.

The sub-band synthesis module is configured for performing sub-band synthesis on the updated sub-band adaptive filter coefficients to obtain updated time domain adaptive filter coefficients.

The anti-noise module is configured for processing a newly input time domain reference signal based on the updated time domain adaptive filter coefficients to obtain an anti-noise signal, thereby controlling road noise based on the anti-noise signal.

Compared with the related art, the beneficial effects of the apparatus for processing vehicle road noise provided in the embodiment of the present application are the same as the beneficial effects of the method for processing vehicle road noise provided in the above embodiment, and the other technical features of the apparatus for processing vehicle road noise are the same as the features disclosed in the method of the above embodiment, and are not further described here.

The embodiments of the present application provide a device for processing vehicle road noise, including: at least one processor; and a memory communicatively connected to the at least one processor; and the memory stores instructions executable by the at least one processor, and the instructions are executed by the at least one processor to enable the at least one processor to perform the method for processing vehicle road noise described in the above embodiment.

As shown in FIG. 7, which illustrates a schematic structural diagram of a device for processing vehicle road noise suitable for implementing embodiments of the present application. The device for processing vehicle road noise in embodiments of the present application may be a control unit in an RNC system. The device for processing vehicle road noise illustrated in FIG. 7 is merely an example and is not intended to limit the functionality or scope of application of embodiments of the present application.

As shown in FIG. 7, the device for processing vehicle road noise may include a processing device 1001 (e.g., a DSP processor) that can perform various appropriate actions and processes based on programs stored in a read-only memory 1002 or loaded from a storage device 1003 into a random access memory 1004. The random access memory 1004 also stores various programs and data required for the operation of the device for processing vehicle road noise. The processing device 1001, the read-only memory 1002, and the random access memory 1004 are interconnected via a bus 1005. An input/output interface 1006 is also connected to the bus. Typically, the following systems may be connected to the input/output interface 1006: input devices 1007 including, for example, microphones and accelerometers; output devices 1008 including, for example, speakers and vibrators; storage devices 1003 including, for example, magnetic tapes and hard disks; and communication devices 1009. Communication devices 1009 may allow the device for processing vehicle road noise to communicate with other devices wirelessly or by wire to exchange data. While the figure illustrates the device for processing vehicle road noise with various systems, it should be understood that not all of the illustrated systems are required to be implemented or present. More or fewer systems may alternatively be implemented or present.

In particular, according to the embodiments disclosed in the present application, the processes described above with reference to the flowcharts can be implemented as computer software programs. For example, the embodiments disclosed in the present application include a computer program product including a computer program carried on a computer-readable medium, the computer program including program code for executing the method shown in the flowchart. In such an embodiment, the computer program can be downloaded and installed from a network via a communication device, or installed from a storage device 1003, or installed from a read-only memory 1002. When the computer program is executed by the processing device 1001, the above-mentioned functions defined in the method of the embodiment disclosed in the present application are performed.

Compared to the prior art, the beneficial effects of the device for processing vehicle road noise provided in the embodiments of the present application are similar to those of the method for processing vehicle road noise provided in the aforementioned embodiments. Other technical features of the device for processing vehicle road noise are the same as those disclosed in the aforementioned embodiments and are not further elaborated here.

It should be understood that the various components disclosed in the embodiments of the present application can be implemented using hardware, software, firmware, or a combination thereof. In the description of the aforementioned embodiments, specific features, structures, materials, or characteristics may be combined in any suitable manner in any one or more embodiments or examples.

The above description is merely a specific embodiment of this application, but the scope of protection of the present application is not limited thereto. Any modifications or substitutions that can be readily conceived by persons skilled in the art within the technical scope disclosed in the present application are intended to be covered by the scope of protection of the present application. Therefore, the scope of protection of the present application shall be subject to the scope of protection of the claims.

An embodiment of the present application provides a computer-readable storage medium having computer-readable program instructions (i.e., a computer program) stored thereon, and the computer-readable program instructions are used to execute the method for processing vehicle road noise in the above embodiment.

The computer-readable storage medium provided in the embodiments of the present application may be, for example, a USB flash drive, but is not limited to electrical, magnetic, optical, electromagnetic, infrared, or semiconductor systems or devices, or any combination thereof. More specific examples of computer-readable storage media may include, but are not limited to, an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In this embodiment, the computer-readable storage medium may be any tangible medium containing or storing a program that can be used by or in conjunction with an instruction execution system or device. The program code contained on the computer-readable storage medium may be transmitted using any suitable medium, including, but not limited to, wires, optical cables, radio frequency (RF), etc., or any suitable combination thereof.

The computer-readable storage medium may be included in the device for processing vehicle road noise, or it may exist independently and not be incorporated into the device for processing vehicle road noise.

The computer-readable storage medium carries one or more programs. When executed by the device for processing vehicle road noise, these one or more programs enable the device for processing vehicle road noise to perform the functions defined in the method of the embodiments disclosed herein.

Computer program code for carrying out the operations of the present application may be written in one or more programming languages, or a combination thereof, including object-oriented programming languages such as Java, Smalltalk, and C++, as well as conventional procedural programming languages such as C or similar programming languages. The program code may execute entirely on the user's computer, partially on the user's computer, as a stand-alone software package, partially on the user's computer and partially on a remote computer, or entirely on the remote computer or server. Where a remote computer is involved, the remote computer may be connected to the user's computer through any type of network, including a local area network (LAN) or a wide area network (WAN), or may be connected to an external computer (e.g., through the Internet using an Internet service provider).

The flowcharts and block diagrams in the accompanying drawings illustrate the possible implementation architecture, functions and operations of the systems, methods and computer program products according to various embodiments of the present application. In this regard, each box in the flowchart or block diagram can represent a module, program segment or part of code, and the module, program segment or part of code contains one or more executable instructions for implementing the specified logical function. It should also be noted that in some alternative implementations, the functions marked in the box can also occur in an order different from that marked in the accompanying drawings. For example, two boxes represented in succession can actually be executed substantially in parallel, and they can sometimes be executed in the opposite order, depending on the functions involved. It should also be noted that each box in the block diagram and/or flowchart, as well as the combination of boxes in the block diagram and/or flowchart, can be implemented using a dedicated hardware-based system that performs the specified function or operation, or can be implemented using a combination of dedicated hardware and computer instructions.

The modules described in the embodiments of the present application may be implemented in software or hardware, wherein the name of a module does not necessarily limit the unit itself.

The readable storage medium provided in the embodiments of the present application is a computer-readable storage medium, which stores computer-readable program instructions (i.e., a computer program) for executing the above-mentioned vehicle road noise processing method. Compared with the prior art, the beneficial effects of the computer-readable storage medium provided in the embodiments of the present application are the same as the beneficial effects of the method for processing vehicle road noise provided in the above-mentioned embodiments, and are not further elaborated here.

The present application also provides a computer program product, including a computer program. When executed by a processor, the computer program implements the steps of the aforementioned method for processing vehicle road noise.

Compared to the prior art, the computer program product provided by the present application provides the same beneficial effects as the method for processing vehicle road noise provided by the aforementioned embodiment, and therefore will not be further elaborated here.

The above description is only part of the embodiments of the present application and does not limit the patent scope of the present application. All equivalent structural transformations made by using the contents of the present application specification and drawings under the technical concept of the present application, or direct/indirect application in other related technical fields are included in the patent protection scope of the present application.

What is claimed is:

1. A method for processing vehicle road noise, comprising:
performing sub-band decomposition on an input time domain reference signal and an input time domain error signal to obtain a sub-band reference signal and a sub-band error signal;
dynamically determining a target update step size corresponding to sub-band adaptive filter coefficients based on acquired influencing factor information, wherein the influencing factor information comprises environmental state information and/or sensor state information, the environmental state information is information representing an environmental state inside and/or outside a vehicle, the sensor state information is information representing an operating state of a sensor, and the sensor comprises the sensor for collecting the time domain reference signal and/or the sensor for collecting the time domain error signal;
updating the sub-band adaptive filter coefficients according to the target update step size based on the sub-band reference signal and the sub-band error signal;
performing sub-band synthesis on the updated sub-band adaptive filter coefficients to obtain updated time domain adaptive filter coefficients; and
processing a newly input time domain reference signal based on the updated time domain adaptive filter coefficients to obtain an anti-noise signal, thereby controlling road noise based on the anti-noise signal.

2. The method according to claim 1, wherein when dynamically determining the target update step size based on the influencing factor information, one or more of the following rules is met:
under the environmental state represented by the environmental state information, the target update step size corresponding to a sub-band with higher road noise energy or higher stability is larger than the target update step size corresponding to a sub-band with lower road noise energy or lower stability;
for any target sub-band, the higher the energy or the higher the stability of the vehicle road noise in the target sub-band under the environmental state represented by the environmental state information, the larger the target update step size corresponding to the target sub-band; and the lower the energy or the lower the stability of the vehicle road noise in the target sub-band under the environmental state represented by the environmental state information, the smaller the target update step size corresponding to the target sub-band;
based on abnormality level of each sensor represented by the sensor state information, the target update step size corresponding to the sub-band containing the sensor with higher abnormality level is smaller than the target update step size corresponding to the sub-band containing the sensor with lower abnormality level; and
for any target sub-band, the higher the abnormality level of the sensor in the target sub-band, the smaller the target update step size corresponding to the target sub-band; and the lower the abnormality level of the sensor in the target sub-band, the larger the target update step size corresponding to the target sub-band.

3. The method according to claim 2, wherein the dynamically determining the target update step size corresponding to the sub-band adaptive filter coefficients based on the acquired influencing factor information comprises:
determining an update step length corresponding to the influencing factor information as a target update step length according to a preset mapping relationship, wherein the mapping relationship satisfies one or more of the above rules.

4. The method according to claim 1, wherein the influencing factor information further comprises a vehicle speed, and when dynamically determining the target update step size based on the influencing factor information, one or more of the following rules is met:
the higher the vehicle speed stability, the larger the target update step size corresponding to each sub-band; and the lower the vehicle speed stability, the smaller the target update step size corresponding to each sub-band; and
the target update step size corresponding to each sub-band when the vehicle speed is beyond a preset range is smaller than the target update step size corresponding to each sub-band when the vehicle speed is within the preset range.

5. The method according to claim 1, further comprising:
performing prediction based on the input time domain reference signal, the input time domain error signal, the sub-band reference signal and the sub-band error signal through a preset prediction model to obtain the environmental state information and/or the sensor state information, wherein the prediction model is pre-trained.

6. The method according to claim 5, wherein the prediction model comprises a first feature extraction module, a second feature extraction module, a third feature extraction module, a feature fusion module and a prediction module;
the performing prediction based on the input time domain reference signal, the input time domain error signal, the sub-band reference signal and the sub-band error signal through the preset prediction model to obtain the environmental state information and/or the sensor state information comprises:
inputting the sub-band reference signal and the sub-band error signal into the first feature extraction module for feature extraction to obtain a first feature representation;
inputting the input time domain reference signal into the second feature extraction module for feature extraction to obtain a second feature representation;
inputting the input time domain error signal into the third feature extraction module for feature extraction to obtain a third feature representation;
concatenating the first feature representation, the second feature representation, and the third feature representation and inputting into the feature fusion module for feature fusion to obtain a fused feature representation; and
inputting the fused feature representation into the prediction module for prediction to obtain the environmental state information and/or the sensor state information.

7. The method according to claim 6, wherein:
each of the first feature extraction module, the second feature extraction module, and the third feature extraction module comprises at least one convolutional layer;
the feature fusion module comprises a frequency-axis gated recurrent unit, a time-axis gated recurrent unit, and at least one transposed convolutional layer connected in sequence; and
the prediction module comprises multiple task output layers, and each task output layer is configured to output the environmental state information or the sensor state information.

8. The method according to claim 7, wherein the prediction module further comprises a shared feature extraction layer disposed before the multiple task output layers, and the shared feature extraction layer comprises one or more convolutional layers.

9. The method according to claim 7, wherein the environmental state information comprises weather condition information and road condition information.

10. The method according to claim 5, wherein a frame index of the input time domain reference signal and the input time domain error signal is 1, and the method further comprises:
during N interrupts in (l+1)th frame, performing a task allocated to the N interrupts, wherein N represents a frame length, and interrupt refers to a period between generating an anti-noise signal based on the time domain reference signal at each sampling point and receiving the time domain reference signal at a next sampling point; and
wherein the task allocated to the N interrupts comprises the task for calculating the updated time domain adaptive filter coefficients, and/or the task for predicting the environmental state information and/or the sensor state information through the prediction model.

11. The method according to claim 10, wherein:
the task for calculating the updated time domain adaptive filter coefficients is divided into a sub-band decomposition task, a sub-band synthesis task, and a multiple sub-band update task;
each sub-band update task comprises: updating at least one sub-band adaptive filter coefficient, assigning the sub-band decomposition task to a first preset number of interrupts for execution, assigning the sub-band synthesis task to a second preset number of interrupts for execution, and assigning the multiple sub-band update task to a third preset number of interrupts for execution, with one sub-band update task assigned to each interrupt; and
a sum of the first preset number, the second preset number, and the third preset number is N.

12. The method according to claim 1, wherein the updating the sub-band adaptive filter coefficients according to the target update step size based on the sub-band reference signal and the sub-band error signal comprises:
convolving the sub-band reference signal with a pre-established secondary path model; and
calculating updated sub-band adaptive filter coefficients through a complex-domain LMS algorithm based on the sub-band error signal, the sub-band reference signal after convolution with the secondary path model, and the current sub-band adaptive filter coefficients.

13. The method according to claim 1, wherein the sensor for collecting the time domain reference signal comprises at least one vibration sensor, and the sensor for collecting the time domain error signal comprises at least one microphone.

14. The method according to claim 13, wherein the influencing factor information further comprises signal characteristics of the vibration sensor, and the signal characteristic comprises acceleration amplitude, energy, and sound pressure signal amplitude.

15. The method according to claim 1, wherein the performing sub-band decomposition on the input time domain reference signal and the input time domain error signal to obtain the sub-band reference signal and the sub-band error signal comprises:
performing preprocessing on the input time domain reference signal and the input time domain error signal, and performing sub-band decomposition on the preprocessed time domain reference signal and the preprocessed time domain error signal respectively to obtain the sub-band reference signal and the sub-band error signal, wherein the preprocessing comprises pre-filtering processing and/or amplitude adjustment processing.

16. The method according to claim 1, wherein the processing the newly input time domain reference signal based on the updated time domain adaptive filter coefficients to obtain the anti-noise signal, thereby controlling road noise based on the anti-noise signal comprises:
processing the newly input time domain reference signal based on the updated time domain adaptive filter coefficients to generate the anti-noise signal; and
playing the anti-noise signal through a speaker located within the vehicle, or post-processing the anti-noise signal and playing the anti-noise signal through the speaker located within the vehicle.

17. An apparatus for processing vehicle road noise, comprising:
a sub-band decomposition module, configured for performing sub-band decomposition on an input time domain reference signal and an input time domain error signal to obtain a sub-band reference signal and a sub-band error signal;
a step size updating module, configured for dynamically determining a target update step size corresponding to sub-band adaptive filter coefficients based on acquired influencing factor information, wherein the influencing factor information comprises environmental state information and/or sensor state information, the environmental state information is information representing an environmental state inside and/or outside a vehicle, the sensor state information is information representing an operating state of a sensor, and the sensor comprises the sensor for collecting the time domain reference signal and/or the sensor for collecting the time domain error signal;
a filter updating module, configured for updating the sub-band adaptive filter coefficients according to the target update step size based on the sub-band reference signal and the sub-band error signal;
a sub-band synthesis module, configured for performing sub-band synthesis on the updated sub-band adaptive filter coefficients to obtain updated time domain adaptive filter coefficients; and
an anti-noise module, configured for processing a newly input time domain reference signal based on the updated time domain adaptive filter coefficients to obtain an anti-noise signal, thereby controlling road noise based on the anti-noise signal.

18. A device for processing vehicle road noise, comprising: a memory, a processor, and a computer program stored in the memory and executable on the processor, wherein the computer program is configured to implement the method for processing vehicle road noise according to claim 1.

19. A non-transitory computer-readable storage medium, wherein the non-transitory computer-readable storage medium stores a computer program, and when the computer program is executed by a processor, the method for processing vehicle road noise according to claim 1 is implemented.

20. A computer program product, wherein the computer program product comprises a computer program, and when the computer program is executed by a processor, the method for processing vehicle road noise according to claim 1 is implemented.
